(19) United States
(12) Patent Application Publication
(10) Pub. No.: US 2011/0064963 A1
(43) Pub. Date: Mar. 17, 2011

(54) THERMAL SPRAY PROCESSES AND ALLOYS FOR USE IN SAME

(76) Inventors: Justin Lee Cheney, San Francisco, CA (US); John Hamilton Madok, San Diego, CA (US)

(21) Appl. No.: 12/569,713

(22) Filed: Sep. 29, 2009

Related U.S. Application Data
(60) Provisional application No. 61/243,498, filed on Sep. 17, 2009.

(51) Int. Cl. B32B 15/01; B23K 1/20; B23K 31/02; B23K 35/02

(52) U.S. Cl. 428/576; 228/208; 228/176

(57) ABSTRACT

The present invention provides a method for coating an article comprising applying a thermal spray coating to the article; applying a brazing material to the article; and heating the brazing material to at least a brazing temperature of the brazing material to form a resultant coating on the article, wherein the resultant coating is characterized by at least partial metallurgical bonding or at least partial alloying between the thermal spray coating and the brazing material.

### CROSS-REFERENCE TO RELATED APPLICATIONS

This application claims priority from Provisional U.S. Application Ser. No. 61/243,498 filed Sep. 17, 2009, which is hereby incorporated herein by reference in its entirety.

### TECHNICAL FIELD

The present invention relates generally to metallurgy, and more particularly, some embodiments relate to coating technology.

### DESCRIPTION OF THE RELATED ART

Thermal spray processing is a technique used to apply a coating onto a substrate material. Often, the coating material is used to give the substrate enhanced surface properties. Also, the technique can be used to repair the substrate after damage or improper machining. Techniques for thermal spray processing involve using a spray gun to impart the coating material with a sufficient amount of energy such that it impacts and sticks via a mechanical bond. In these processes, molten or semi-molten droplets or particles of the coating material are impacted with the substrate material. Once deposited, these droplets or particles are often called “splats” owing to the plate-like appearance of the deposited particles. In many cases, the surface of the substrate is prepared by sandblasting to create asperities on the surface for the coating material to attach to. Some porosity in the coating is inevitable, and is a function of the material, spray parameters, and technique used (HVOF, plasma, combustion, TWAS, etc.).

Although mechanical bonding is the primary technique for coating adhesion to the surface, some materials are said to be self-bonding and form a limited metallurgical bond between the substrate/coating and between the individual splat particles that impact the surface during the spray process. The amount of coating that may be deposited in one application is typically limited by the residual stress caused by particle shrinkage upon cooling. If this residual stress exceeds the bond strength of the coating, the coating may peel off the substrate. To improve coating adhesion for a variety of coating types, a primary layer of an improved bonding material is often layered down before the desired coating material is applied.

### BRIEF SUMMARY OF EMBODIMENTS OF THE INVENTION

Some embodiments of the invention provide The present invention provides a method for coating an article comprising applying a thermal spray coating to the article; applying a brazing material to the article; and heating the brazing material to at least a brazing temperature of the brazing material to form a resultant coating on the article, wherein the resultant coating is characterized by at least partial metallurgical bonding or at least partial alloying between the thermal spray coating and the brazing material.

In further embodiments, the brazing material comprises a nickel-based braze alloy or a Fe and Ni based braze alloy, and the thermal spray coating comprising an amorphous or partially amorphous metallic compound. In some embodiments, the brazing material or thermal spray coating material comprises a metal formed according to at least one of the formulae Fe₅₄₋₇₅Cr₉₋₁₅ Ni_{0-4.8}(Mo,Nb)_{7.9-13}C_{1.6-3}B_{1.3-4.6}W₀₋₁₁Ti₀₋₇Si_{0-1.1}Mn_{0-1.1}; (Fe₆₁₋₇₅Cr_{9-14.4} Ni_{0-4.8}(Mo,Nb)_{6-11.7}C_{1.6-2.1}B_{1.3-4.6}W_{0-9.98}Ti₀₋₇S_{0-1.1}Mn_{0-1.1})₁₀₀₋ₓAlₓ where x ranges from 0.5-10; Fe₆₂₋₆₆Cr₁₃₋₂₅(Mo,Nb)₄₋₁₂(C,B)_{2.2-4.4}Ni_{0-4.8}Si_{0-1.5}Mn_{0-1.2}W_{0-3.8}; Fe₆₁₋₇₆Cr_{9-14.4} Ni₀₋₅(Mo,Nb)_{7.9-11.7}C_{1-6-2.1}B_{1.3-5}W_{0-9.98}Si_{0-1.5}Mn_{0-1.1}; and Fe₆₂₋₆₆Cr₁₃₋₂₅(Mo,Nb)₄₋₁₂(C,B)_{0-4.4}Ni₀₋₅Si_{0-1.5}Mn_{0-1.2}W_{0-3.8}.

In still further embodiments, an article such as a substrate is coated with a brazing material and heated such that the brazing material diffuses into the substrate, thereby creating a compositional gradient from the surface of the material into the bulk of the material.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

FIGS. 1A and 1B illustrate a method of coating according to an embodiment of the invention.

FIGS. 2A and 2B illustrate a method of forming a coated article according to an embodiment of the invention.

FIGS. 3A and 3B illustrate another method of forming a coated article according to an embodiment of the invention

FIGS. 4A and 4B illustrate a further method of creating a coated article according to an embodiment of the invention.

FIGS. 5A and 5B illustrate another method of creating a coated article according to an embodiment of the invention.

FIG. 6 illustrates a cored wire having a solid wire core in addition to a powder fill core according to an embodiment of the invention.

FIG. 7 illustrates three example types coatings according to embodiments of the invention.

FIG. 8 illustrates a method for removing a coating according to an embodiment of the invention.

FIG. 9 illustrates two removed coatings created using the method described with respect to FIG. 8.

FIG. 10 illustrates a resultant coating formed according to the method described with respect to FIG. 2 on a substrate before heat treatment.

FIG. 11 illustrates the microstructure of this example resultant coating after a heat treatment step.

FIG. 12 is a close-up micrograph of a region near the coating/substrate interface for the resultant coating imaged in FIG. 11.

FIG. 13 is a close-up micrograph of a region near the exterior surface of the resultant coating of FIG. 11.

FIG. 14 illustrates a non-heat treated resultant coating formed according to the method described with respect to FIG. 5A.

FIG. 15 is an x-ray diffraction spectra for this coating.

FIG. 16 is a micrograph the resultant coating after heat treating the coating of FIG. 14.

FIG. 17 is a graph illustrating the results of a resultant fused coating as compared to weld-overlays in the ASTM G65 Dry Sand Wear Test.

FIG. 18 illustrates an inventive resultant coating formed according to the method described with respect to FIG. 2.

FIG. 19 illustrates a metallurgical bond between a substrate and a resultant coating formed according to the method described with respect to FIG. 2.

FIG. 20 is an optical micrograph of a coating formed according to an embodiment of the invention.

FIG. 21 is a graph showing the results of the ASTM C 633 tensile strength test of various embodiments of the invention.

FIG. 22 illustrates the results of the ASTM G77 test (Block on Ring) showing the wear resistance as measured for various embodiment of the invention.

FIG. 23 illustrates the results for the indicated coatings under the ASTM G105 (Wet Sand Rubber Wheel) test.

FIG. 24 illustrates the results for the indicated coatings under the ASTM G65 (Dry Sand Rubber Wheel) test.

FIG. 25 shows the galvanic series of several well known materials in addition to the materials discussed in this patent.

FIG. 26 shows a micrograph of a brazed joint between stainless steel and an Fe-based metallic glass using Ni₅₂B₁₇Si₃ as the brazing material.

FIG. 27 shows a micrograph of a brazed joint between stainless steel and an Fe-based metallic glass using Ni₅₅B₁₈Cr.₄Fe₂₄ as the brazing material.

FIG. 28 shows a micrograph of a brazed joint between stainless steel and an Fe-based metallic glass using Ni₅₄B₁₄Si₄Cr₄Fe₂₄ as the brazing material.

FIG. 29 shows a micrograph of a resultant coating produced via complete alloying between the brazing material Fe₄₃Cr₃₃Ni₁₀B₁₄ and an Fe-based metallic glass.

FIG. 30 is a comparison between a twin wire arc spray coating and a fused coating formed according to the method described with respect to FIG. 2.

FIG. 31 illustrates the results of a test comparison under corrosive conditions in salt water with 316 stainless steel serving as the reference electrodes.

FIG. 32 illustrates the hardness of and galvanic potential of thermal spray coatings in the combinations illustrated.

FIG. 33 is an optical micrograph of a resultant coating formed by 8 mils pre-coating of Fe_{65.9}Cr_{24.6}Nb_{4.6}B_{2.2}Si_{1.5}Mn_{1.2} followed by 15 mil coating of Fe_{65.6}Cr_{14.5}Nb_{8.6}B_{4.2}Ni_{4.8}Si_{1.1}Mn_{1.2} that was heat treated in vacuum for 5 min at 1175 C.

FIG. 34 is an optical micrograph of a resultant coating formed by 8 mils pre-coating of BNi-1a followed by 15 mil coating of Fe_{65.6}Cr_{14.5}Nb_{8.6}B_{4.2}Ni_{4.8}Si_{1.1}Mn_{1.2} heat treated in vacuum for 5 min at 1175 C.

FIG. 35 is an optical micrograph of a coating formed by 8 mils pre-coating of BNi-1a followed by 15 mil coating of Fe₇₂Cr₁₃Nb₆Ni₅Si₁Mn₁Al₂ heat treated in vacuum for 5 min at 1175 C.

FIG. 36 is an optical micrograph of a coating formed by 8 mils pre-coating of Fe_{65.9}Cr_{24.6}Nb_{4.6}B_{2.2}Si_{1.5}Mn_{1.2} followed by 15 mil coating of Fe₇₂Cr₁₃Nb₆Ni₅Si₁Mn₁Al₂ heat treated in vacuum for 5 min at 1175 C.

FIG. 37 is an optical micrograph of a coating formed by 8 mils pre-coating of BNi-3 followed by 15 mil coating of Fe_{65.9}Cr_{24.6}Nb_{4.6}B_{2.2}Si_{1.5}Mn_{1.2} heat treated in vacuum for 5 min at 1175 C.

FIG. 38 shows a microstructure of an embodiment where spraying 15 mils of Fe_{65.9}Cr_{24.6}Nb_{4.6}B_{2.2}Si_{1.5}Mn_{1.2} were sprayed onto a substrate and heat treated for at least 5 min at 1200 C or above.

FIG. 39 shows the compositional gradient of this coating as measured using electron dispersion spectrometry in a SEM.

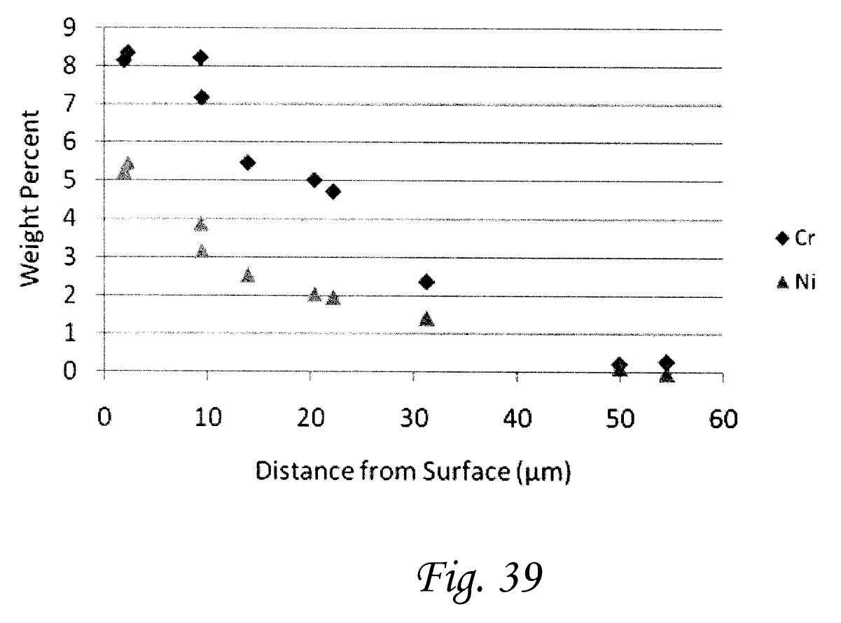

FIG. 40 shows a microstructure of a resultant coating according to an embodiment of the invention.

FIG. 41 illustrates the results of a corrosion test where the two cored wires of similar relative composition expect for the aluminum, were placed in a galvanic cell relative to 316 stainless steel with natural saltwater from the San Francisco Bay as the electrolytic solution.

The figures are not intended to be exhaustive or to limit the invention to the precise form disclosed. It should be understood that the invention can be practiced with modification and alteration, and that the invention be limited only by the claims and the equivalents thereof.

### DETAILED DESCRIPTION OF THE EMBODIMENTS OF THE INVENTION

Some embodiments of the invention provide methods for forming coatings and compounds that may be used in these methods. In some embodiments of the invention, a coated article is created by coating an article with a thermal spray coating and a brazing material. In some embodiments, this may comprise coating the article with the brazing material and then applying the thermal spray coating to the braze coated article. In other embodiments, this may comprise coating the article with the thermal spray coating and then applying the brazing material to the thermal spray coated article. In still further embodiments, the thermal spray coating material and brazing material may be combined prior to application, and the combination may be applied to the article. The heat present during the coating application, or a subsequent heat treatment, may be used to cause the brazing material to infiltrate interstitial spaces that occur within the thermal spray coating. Additionally, the brazing material may be caused to at least partially alloy with the thermal spray coating. In the embodiments described herein, many methods of applying the thermal spray coating material and brazing material may be used, such as, for example, high velocity oxygen fuel coating (HVOF), plasma spray coating, plasma, combustion spraying, twin wire arc spray coating (TWAS), etc.

In further embodiments, amorphous, nanocrystalline, or other fine grained metals may be used as the thermal spray coating materials or as the brazing materials. For example, in addition to the materials described herein, the various compounds described in Provisional U.S. Application Ser. No. 61/243,498 filed Sep. 17, 2009. Such compounds might comprise, for example, compounds formed according to one or more of the following formulae: Fe₅₄₋₇₅Cr₉₋₁₅ Ni_{0-4.8}(Mo,Nb)_{7.9-13}C_{1.6-3}B_{1.3-4.6}W₀₋₁₁Ti₀₋₇Si_{0-1.1}Mn_{0-1.1}; (Fe₆₁₋₇₅Cr_{9-14.4} Ni_{0-4.8}(Mo,Nb)_{6-11.7}C_{1.6-2.1}B_{1.3-4.6}W_{0-9.98}Ti₀₋₇Si_{0-1.1}Mn_{0-1.1})₁₀₀₋ₓAlₓ where x ranges from 0.5-10; Fe₆₂₋₆₆Cr₁₃₋₂₅(Mo,Nb)₄₋₁₂(C,B)_{2.2-4.4}Ni_{0-4.8}Si_{0-1.5}Mn_{0-1.2}W_{0-3.8}; Fe₆₁₋₇₆Cr_{9-14.4} Ni₀₋₅(Mo,Nb)_{7.9-11.7}C_{1.6-2.1}B_{1.3-5}W_{0-9.98}Ti₀₋₇Si_{0.1.1}Mn_{0-1.1}; and Fe₆₂₋₆₆Cr₁₃₋₂₅(Mo,Nb)₄₋₁₂(C,B)_{0-4.4}Ni₀₋₅Si_{0-1.5}Mn_{0-1.2}W_{0-3.8}. In other embodiments, the brazing material may comprise a solder or other infiltrating material that is capable of infiltrating the thermal spray coating under proper process conditions.

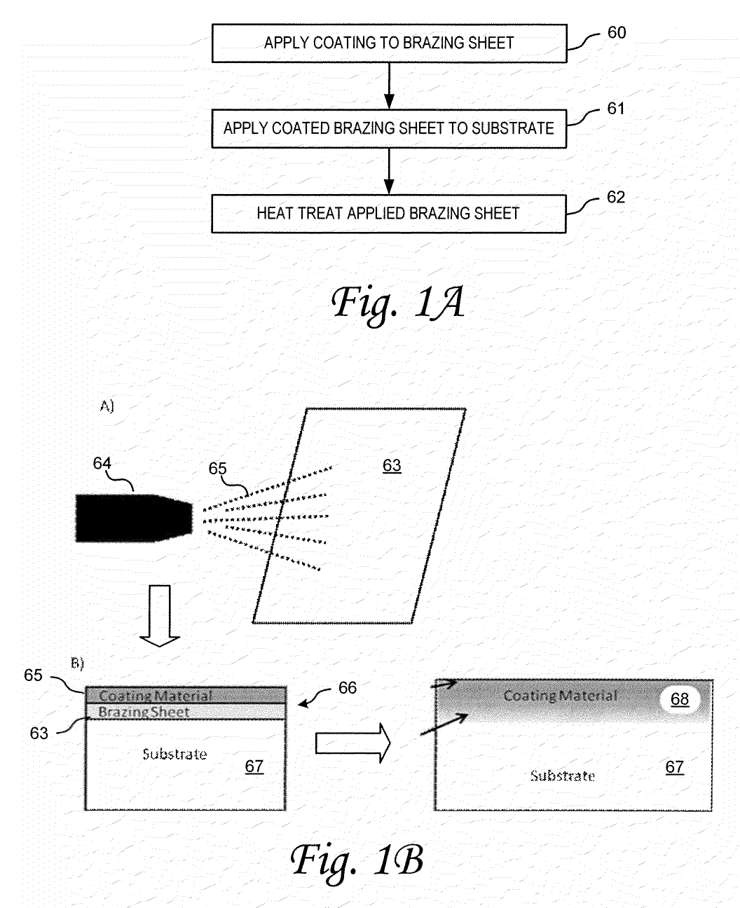

FIGS. 1A and 1B illustrate a method of coating according to an embodiment of the invention. In step 60, a coating of thermal spray material 65 is sprayed using a thermal sprayer 64 onto a sheet of brazing material 63. In step 61, the coated sheet of brazing material 66 is applied to the article 67. Step 62 comprises heat treating the materials to form a resultant coating material 68. In some embodiments, this heat treating step may comprise heating the resultant coating such that the brazing material portion 63 of the resultant coating melts and infiltrates the interstitial spaces formed between splat particles of the thermal spray coating portion 65 of the resultant coating. In these embodiments, the infiltration of the brazing material into the thermal spray coating increases the bonding between the individual finely sprayed particles, and may also decrease the porosity of the thermal spray coating. Furthermore, the integration of the brazing material 63 into the thermal spray coating 65 allows the microstructure of the coating to be tailored and the chemistry to be selected. In further embodiments, the step of heat treating 62 may comprise heating the materials such that at least a portion of the brazing material 63 and thermal spray coating material 65 alloy within the resultant coating 68. In still further embodiments, the coating may be heated such that all, or almost all, of the resultant coating 68 comprises an alloy between the brazing material and the thermal spray coating material.

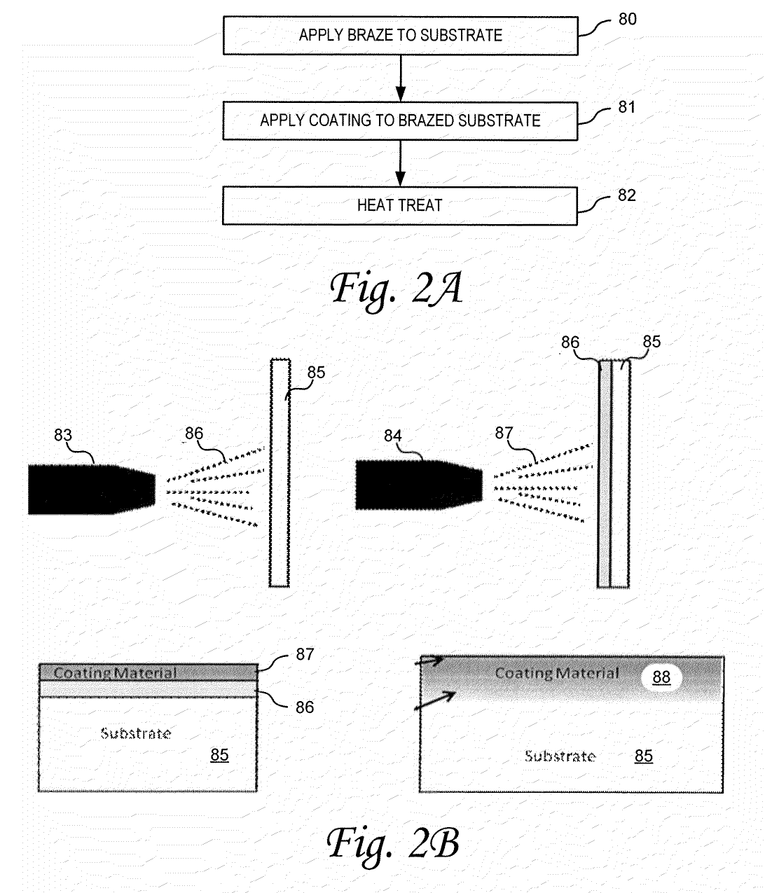

FIGS. 2A and 2B illustrate a method of forming a coated article according to an embodiment of the invention. In this embodiment, a brazing material 80 is applied to an article such as substrate 85. For example, a thermal sprayer 83 may be used to spray the brazing material 86 onto the substrate 85. After the article 85 has been coated with brazing material 86, at step 81, a thermal spray coating, 87, is applied to the brazed substrate 86, 85. In this embodiment, the heat present during the thermal spray processes 83 or 84 may be sufficient to raise the brazing material 86 to its brazing temperature to allow the resultant coating 88 to be formed without a subsequent heat treatment. In other embodiments, a heat treatment step 82 may be performed during creation of the resultant coating 88. Even in embodiments where the heat treatment step 82 may not be necessary for some infiltration between the thermal spray coating material and the brazing material, the heat treatment step may be used to alloy the thermal spray coating material and brazing material or to cause the resultant coating to diffuse into the substrate.

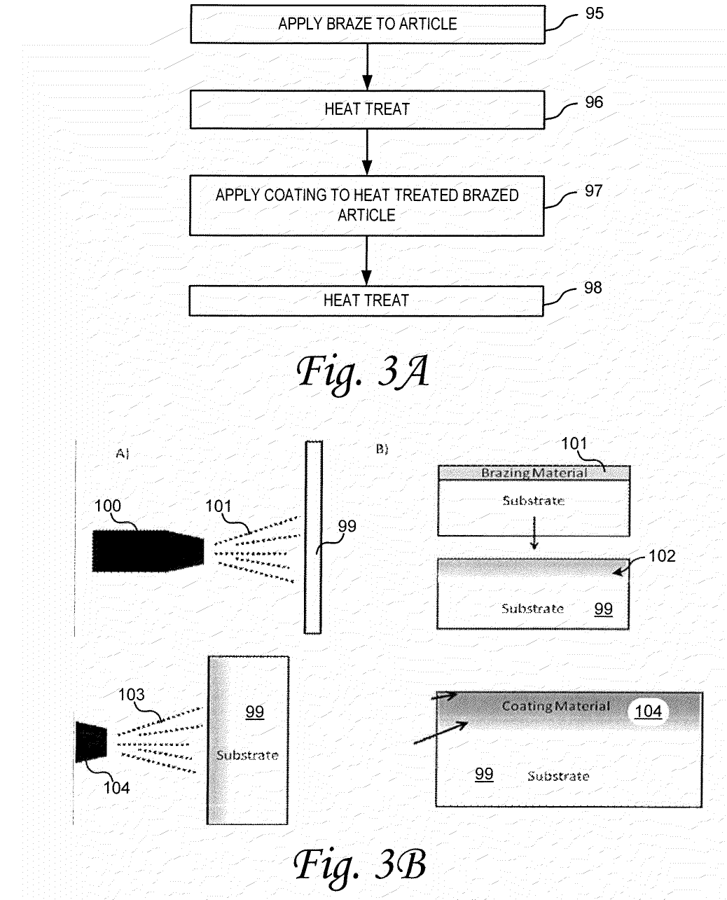

FIGS. 3A and 3B illustrate another method of forming a coated article according to an embodiment of the invention. In this embodiment, a brazing material 101 is applied to the article to be coated 95. For example, a brazing material 101 may be sprayed using a thermal sprayer 100 onto an article such as substrate 99. After the brazing material has been applied to the substrate 99, the article is heat treated in step 96. In this heat treatment step 96, the brazing material 101 is caused to diffuse into the substrate 99, to form a resultant coating that comprises a surface gradient 102. In some embodiments, this pre-treatment of substrate 99 with brazing material 101 improves surface properties of the substrate 99 and assists in bonding the thermal spray coating. After the surface treatment, the thermal spray coating is applied to the heat treated brazed article in step 97. For example, this step may comprise using a thermal sprayer 104 to apply the thermal spray coating 103 to the treated substrate 99. In some embodiments, the pretreatment of the article 99 with the brazing material 101 provides a sufficient bonding surface for the thermal spray coating 103 such that the resultant coating does not require further heat treatment. In other embodiments, an additional heat treatment step 98 may be provided to further refine the resultant coating 104. For example, the heat treatment step 98 may cause some of the brazing material to infiltrate the thermal spray coating, thereby improving the bonding strength of the thermal spray coating 103 to the article 99. In other cases, the heat treatment step might cause the coating material 103 to diffuse into the substrate, such that the resultant coating 104 comprises a modified surface region of the substrate 99.

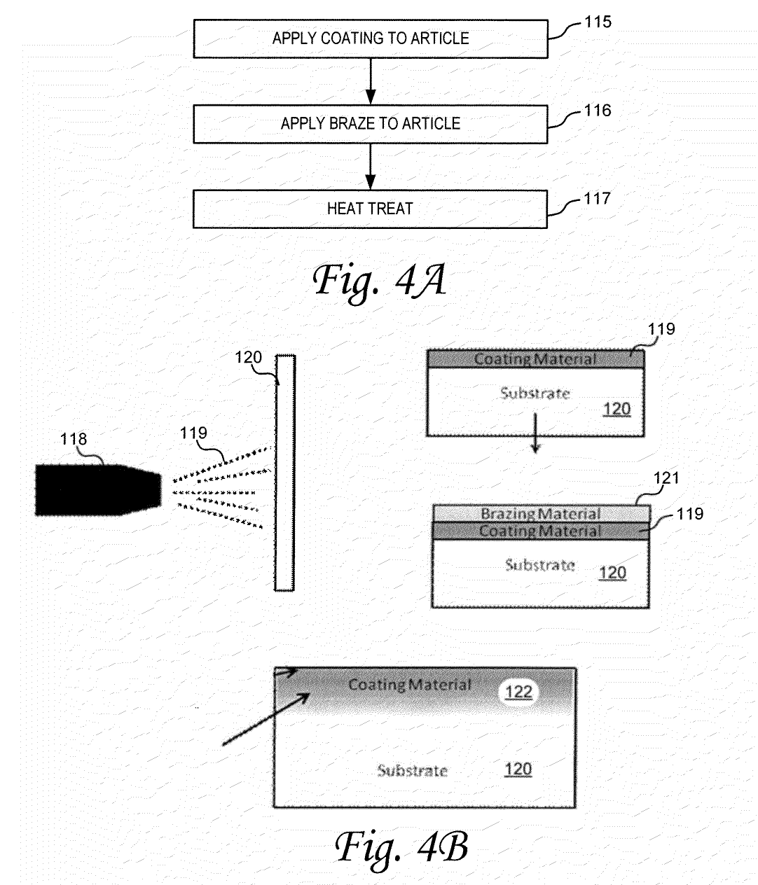

FIGS. 4A and 4B illustrate a further method of creating a coated article according to an embodiment of the invention. Step 115 of this method comprises applying a thermal spray coating 119 to the article to be coated 120. For example, a thermal sprayer 118 may be used to spray the thermal spray coating material 119 onto an article, such as substrate 120. After this spraying step, the article comprises a substrate 120 having a coating 119. Step 116 then comprises applying a brazing material to the article. For example, a sheet of brazing material 121 may be applied to the exterior coated surface of the article. The final step 117 comprises heat treating the resultant article. After this heat treatment, resultant coating 122 comprises the thermal spray coating material 119 combined with the brazing material 121. In some embodiments, it is desirable to form a coating having surface properties similar to that of the thermal spray coating rather than that of the brazing material. Accordingly, in these embodiments, the amount of brazing material applied to the thermal spray coated article may be metered to ensure that substantially all of the brazing material infiltrates during heat treatment. Alternatively, excess brazing material may be removed through a variety of methods.

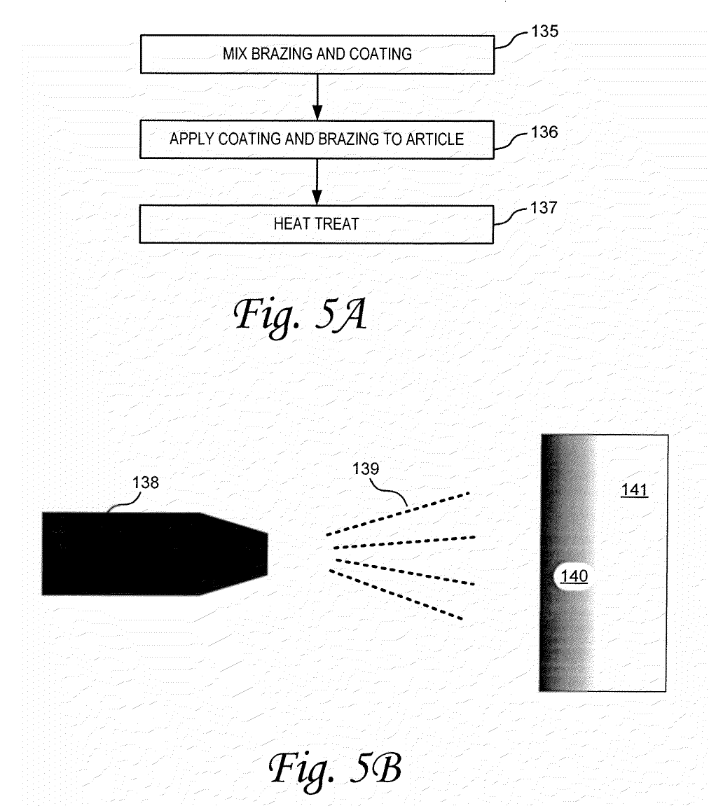

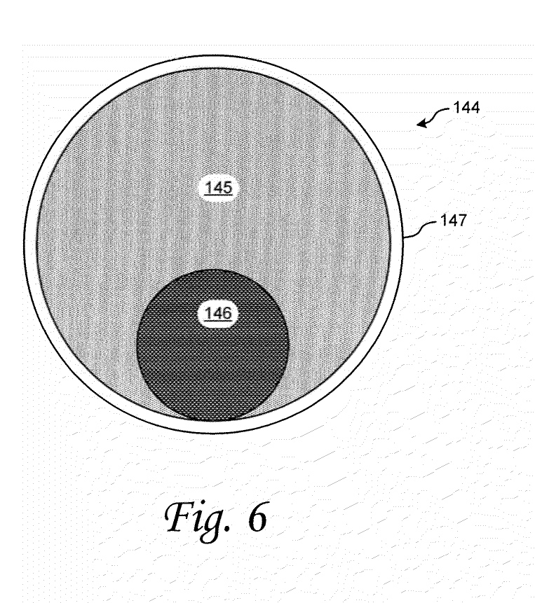

FIGS. 5A and 5B illustrate another method of creating a coated article according to an embodiment of the invention. In this embodiment, in step 135, the brazing material and the thermal spray coating material are mixed together before application, or they are mixed together simultaneously with application. For example, the materials may be mixed together in the form of a cored wire, an example of which is described with respect to FIG. 6; the brazing material and the thermal coating material may comprise separate wires used in a twin wire arc spray coating method; or the brazing material and the thermal spray coating material may be separately but simultaneously sprayed onto the article. After—or concurrently with—the mixing, in step 136, the coating and the brazing material are concurrently applied to the article. For example, a cored wire, an example of which is described with respect to FIG. 6, may be fed into a thermal sprayer 138 so that the mixture 139 is applied to an article, such as substrate 141, to form a resultant coating 140 on contact with the substrate. In some embodiments, this process uses sufficient heat to raise the brazing material to its brazing temperature such that the resultant coating forms without the use of a separate heat treating step. In other embodiments, a heat treatment step 137 may be used to form the resultant coating 140, or to further refine it.

FIG. 6 illustrates an example means of delivering a brazing material and thermal spray material according to an embodiment of the invention. In the illustrated embodiment, a cored wire 144 comprises a wire of brazing material 146 surrounded by a core of powdered thermal spray coating material 145 that is wrapped in a sheath 147. In some embodiments, cored wires of this type may be used in twin wire arc spray coating or weld overlaying to provide a predetermined ratio of brazing material 146 to thermal spray coating material 145. In further embodiments, as described herein, the introduction of aluminum or other elements may assist in the coating processes. Accordingly, such elements may be mixed in powdered form with thermal spray coating material and core 145. In other embodiments, these elements may be used to make up the sheath 147. An example embodiment of this type would comprise a core wire of nickel-based brazing material 146, a powdered core of iron-based thermal spray coating material 145, encapsulated by a sheath 147 of aluminum. In still further embodiments, as described herein, multiple cores and wires may be present within the sheath. For example, in an embodiment employing aluminum, a wire of aluminum may accompany the wire of brazing material within the sheath 147. Although the wire 146 is illustrates as placed off of the center of the wire, in various embodiments different placements may be used. For example, the wire 146 may placed at the center of the wire, or off center of the wire. Moreover, in some embodiments, varying characteristics may be achieved by placing the wire 146 off center to the rear, to the front, or to the sides. For example, a more stable thermal spray may be achieved using two cored wires in a twin wire spray process where the wires 146 are placed towards the rear of the cored wires.

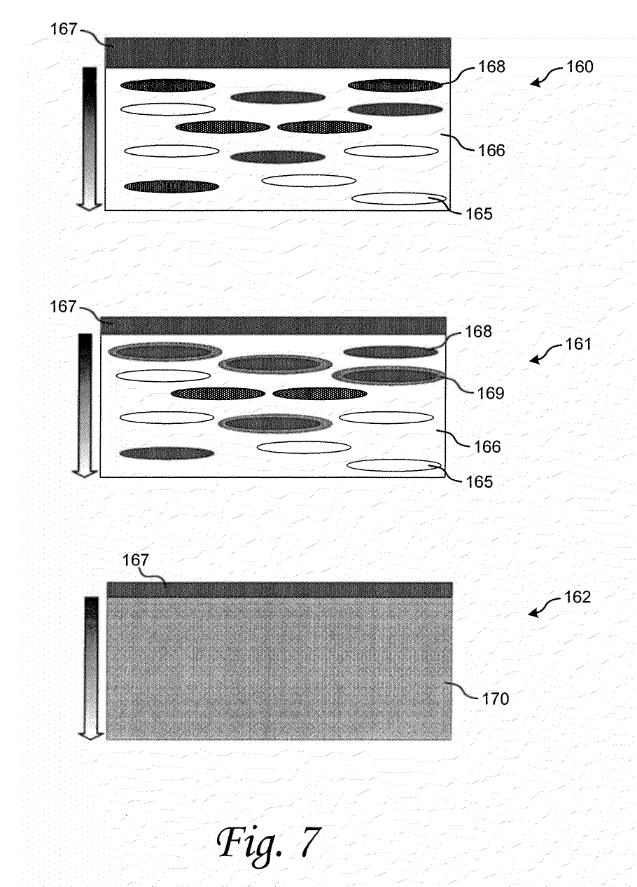

FIG. 7 illustrates three example types of coatings according to embodiments of the invention. As described herein, thermal spray coatings typically comprise a plurality of lamellae or splat particles mechanically, or occasionally metallurgically, bonded together. Accordingly, these coatings are somewhat porous due to interstitial spaces that may comprise, for example, voids or spaces formed between neighboring splat particles, cracks that occur within the coating, or regions of incomplete bonding. In the illustrated thermal spray coatings 166, these interstitial spaces are represented by spaces 165. As described herein, some embodiments of the invention comprise coatings having a brazing material 167 infiltrated with, or alloyed with, the thermal spray coating 166.

Coating 160 illustrates an embodiment where the brazing material 167 is caused to infiltrate the thermal spray coating 166 without alloying to form a composite material. In this embodiment, the application of heat to the coating or coated article results in the brazing material 167 penetrating through a predetermined depth of the coating 167 to at least partially fill at least some of the interstitial spaces 165 that occur within the coating 166. As illustrated by infiltrated spaces 168, among other effects, this infiltration may increase the bond strength within the coating and may reduce the porosity of the coating. In particular embodiments, the reduction of the porosity of the coating increases the corrosion resistance of the resultant coating 160.

Coating 161 illustrates an embodiment where the brazing material 167 is caused to infiltrate the thermal spray coating 166 and to partially alloy with the thermal spray coating 166. In this embodiment, the process is configured such that, in addition to creating infiltrated spaces 168, the brazing material 167 is caused to alloy with the thermal spray coating 166 at locations 169. In various embodiments, this configuration may comprise modifying the temperature, length, or other characteristics of the heat treatment, or selecting different brazing or thermal spray coating materials, or modifying other characteristics of the coating process. In these embodiments, the amount of alloying, or the alloys formed in the coating may spatially vary or may vary according to coating types, relative proportions of the coatings, or other process parameters. In further embodiments, this partial alloying may comprise almost complete alloying. Coating 162 illustrates such an embodiment where the brazing material 167 is caused to alloy with the thermal spray coating to form a new alloy material 170. In these embodiments as well, in complete alloying may still result in a plurality of different alloys within the resultant coating.

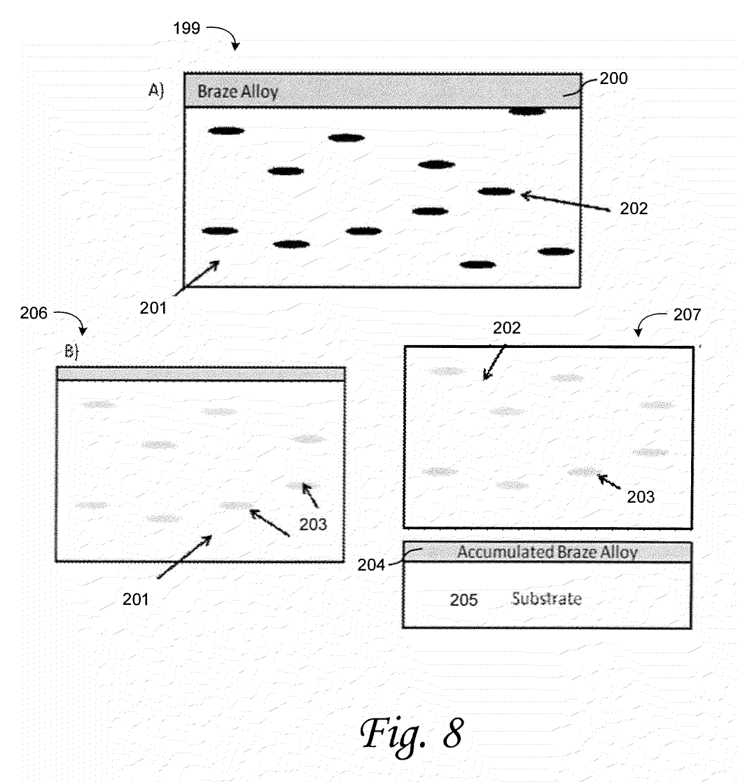

FIG. 8 illustrates a method for removing a coating according to an embodiment of the invention. As described herein, heat treating a braze alloy may tend to cause the braze alloy to infiltrate through the thermal spray coating towards the coated article. As discussed above, the presence of some brazing material between the substrate and the thermal spray coating may tend to increase the bond strength of the thermal spray coating to the thermal spray coating. In further embodiments, this tendency may also be used to form standalone composite materials. In the embodiment illustrated in FIG. 8, in step 199, the thermal spray coating 201 is applied to a substrate and the braze alloy 200 is applied on the outer surface of the thermal spray coating 201. In step 206, an initial heat treatment draws the brazing alloy 200 into the pores or spaces 202 that exist within thermal spray coating 201, thereby creating filled pores or spaces 203. For example, steps 199 and 206 may comprise performing the method described with respect to FIG. 4. In the next step 207, heat treatment is continued until the braze alloy begins to accumulate 204 at the interface between the substrate 205 and the coating 202. After sufficient braze alloy 204 has accumulated in the interface, the bond between the substrate 205 and coating 202 may be reduced sufficiently to allow the coating 202 to be removed. In some embodiments, after this step 207, the removed coating may comprise a composite material comprising a thermal spray coating with pores filled by a brazing material; it may comprise a new material comprised of various alloys between the brazing material and the thermal spray coating; or it may comprise a combination of both of these. These removed coating may be used for various purposes. For example, this method may serve as a method of creating high-strength and impact resistant tiles for a variety of uses, or for creating materials for use in weld overlays.

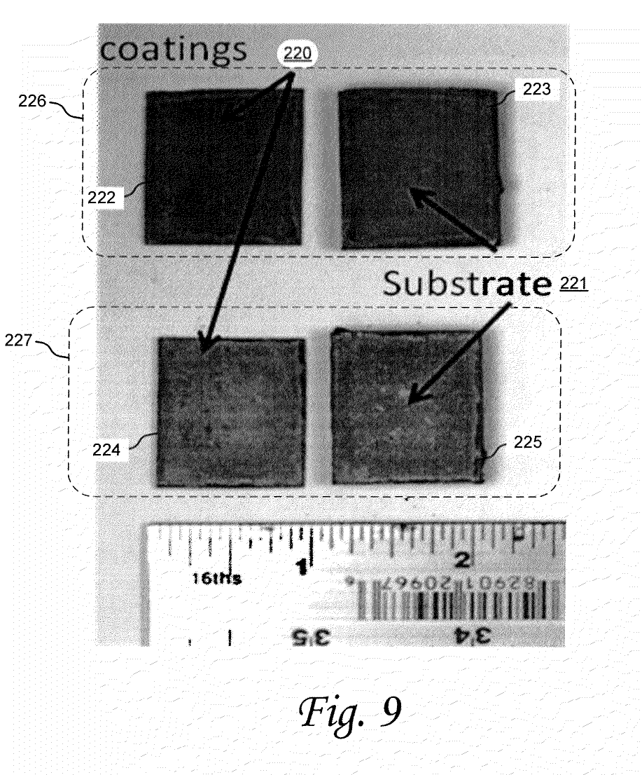

FIG. 9 illustrates two removed coatings 220 created using the method described with respect to FIG. 8. These coatings were formed by first coating a substrate 221 with thermal spray coating. Here, Fe_{63.4}Cr_{9.4}Mo_{12.5}C_{2.5}B_{1.8}W_{10.4} was thermally sprayed on a substrate of mild steel. Approximately 1 mg of silver braze powder, Ag₆₀Cu₃₀Sn₁₀ (in atom percent), was applied to each of the approximately 1 in² coated substrates. Each coated substrate was placed in a furnace at 775° C. Results 226 are a coating 222 and substrate 223 for a coated substrate that was kept in the furnace for approximately 1 min. Results 227 are a coating 224 and substrate 225 for a coated substrate that was kept in the furnace for approximately 5 min. In both cases, the coatings 220 were allowed to slide off the substrates after air-cooling to room temperature.

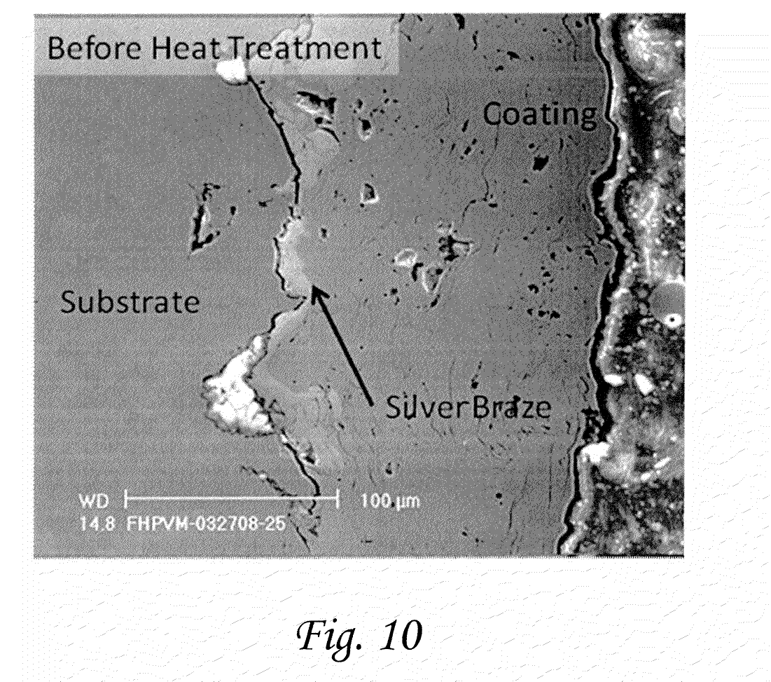

FIGS. 10-13 are micrographs illustrating various features of an inventive coating formed according the method described with respect to FIG. 2. These micrographs, and the other scanning electron micrographs herein, were produced using a backscatter detector in a scanning electron microscope. These micrographs reveal the Z contrast (atomic number contrast), between the present phases. The micrographs further reveal some features of coatings where alloying between the brazing material and the thermal spray coating material does not occur. FIG. 10 illustrates a resultant coating on a substrate before heat treatment. Here, Ag₆₀Cu₃₀Sn₁₀, a silver-based brazing material, which appears as a light gray material, was thermally sprayed onto a mild steel substrate. This was followed by a layer of Fe_{63.4}Cr_{9.4}Mo_{12.5}C_{2.5}B_{1.8}W_{10.4} thermal spray coating material sprayed using the HVOF method, which appears darker than the braze but lighter than the substrate. As this figure illustrates, the brazing material formed a distinct layer between the substrate and the thermal spray coating. In this example, even without heat treatment, this technique increased the tensile bond strength between the thermal spray coating and the substrate 43% over the thermal spray coating and substrate without the brazing material.

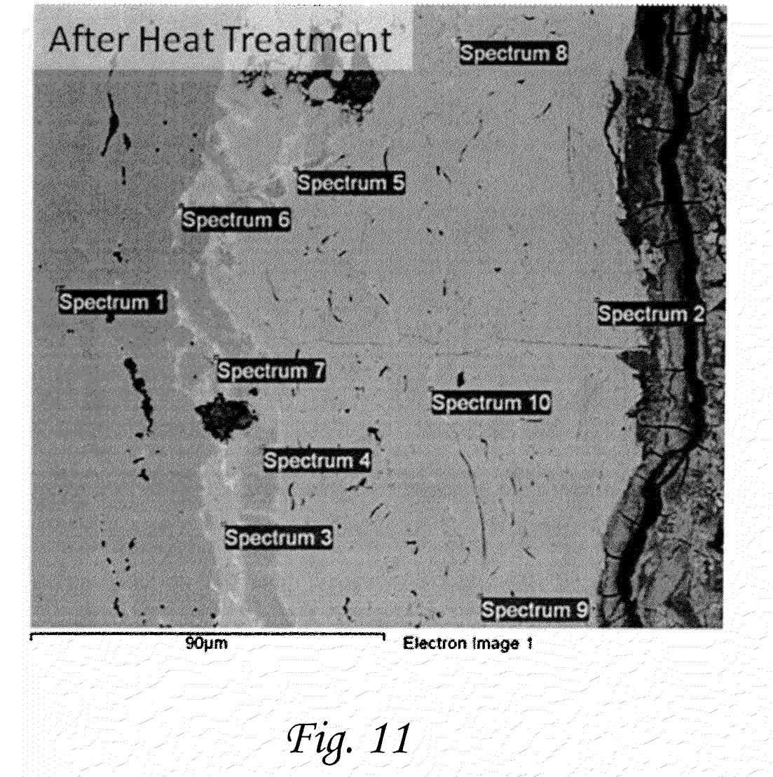

FIG. 11 illustrates the microstructure of this example resultant coating after a heat treatment step. In this example the article was subjected to a heat treatment of 860° C., which is the braze temperature of the brazing material used, for 15 min. Table 1 illustrates the elemental composition of the resultant coating at the locations indicated in FIG. 11. As illustrated by the figure and the accompanying Table 1, the brazing material infiltrated through the thermal spray coating to at least the depth of Spectrum 8's location. This use of the brazing material resulted in a substantial reduction or elimination of porosity from the untreated resultant coating.

In typical HVOF coatings, porosity in the coating remains sufficient to act as a pathway for electrolytic fluids. In both the as sprayed and heat treated coatings, the brazing material reduces this porosity to prevent corrosion of the substrate and damage to the substrate/coating interface. Furthermore, in the heat-treated resultant coating, porosity is further reduced throughout the coating itself, thereby prevent at least some encroachment by corrosive fluids.

TABLE 1
Energy dispersive spectroscopy results accompanying FIG. 11,
revealing composition according to spectrum location.

| Spectrum | Cr | Fe | Cu | Mo | Ag | W |
|---|---|---|---|---|---|---|
| 1 | | 100 | | | | |
| 2 | 9.55 | 52.43 | | 25.86 | | 12.16 |
| 3 | | | 79.22 | | 20.78 | |
| 4 | 3.24 | 73.5 | | 14.83 | | 8.44 |
| 5 | | 26.51 | 5.51 | 32.95 | 20.48 | 14.55 |
| 6 | | 88.13 | | | 11.87 | |
| 7 | | 37.84 | | 16.3 | 36.72 | 9.14 |
| 8 | 6.76 | 43.63 | | 28.35 | 9.87 | 11.38 |
| 9 | 8.82 | 57.38 | | 23.2 | | 10.59 |
| 10 | 7.01 | 43.53 | | 20.92 | 19.05 | 9.49 |

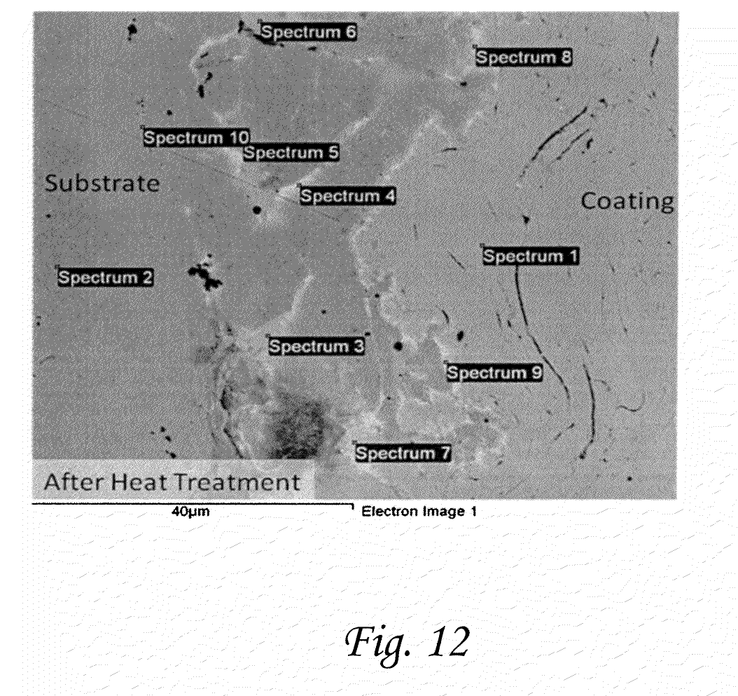

FIG. 12 is a close-up micrograph of a region near the coating/substrate interface for the resultant coating imaged in FIG. 11. Table 2 illustrates the elemental composition of the resultant coating and the substrate at the locations indicated in FIG. 12. As these results indicate, after heat treatment the distinct layer of brazing material diffused into the coating and the substrate, thereby facilitating bonding between the substrate and the resultant coating.

TABLE 2
Energy dispersive spectroscopy results accompanying FIG. 12,
revealing composition according to spectrum location.

| Spectrum | Cr | Fe | Cu | Mo | Ag | W |
|---|---|---|---|---|---|---|
| 1 | 5.95 | 59.74 | | 20.83 | | 13.48 |
| 2 | | 100 | | | | |
| 3 | | 11.68 | 65.3 | | 23.02 | |
| 4 | | 29.87 | | | 70.13 | |
| 5 | | | 70.13 | | 29.87 | |
| 6 | | 8.9 | 73.66 | | 17.44 | |
| 7 | 9.6 | 44.61 | | 23.54 | 9.86 | 12.39 |
| 8 | 4.52 | 30.12 | 1.3 | 34.5 | 16.6 | 12.95 |
| 9 | 4.79 | 31.18 | | 24.48 | 27.97 | 11.58 |
| 10 | | 100 | | | | |

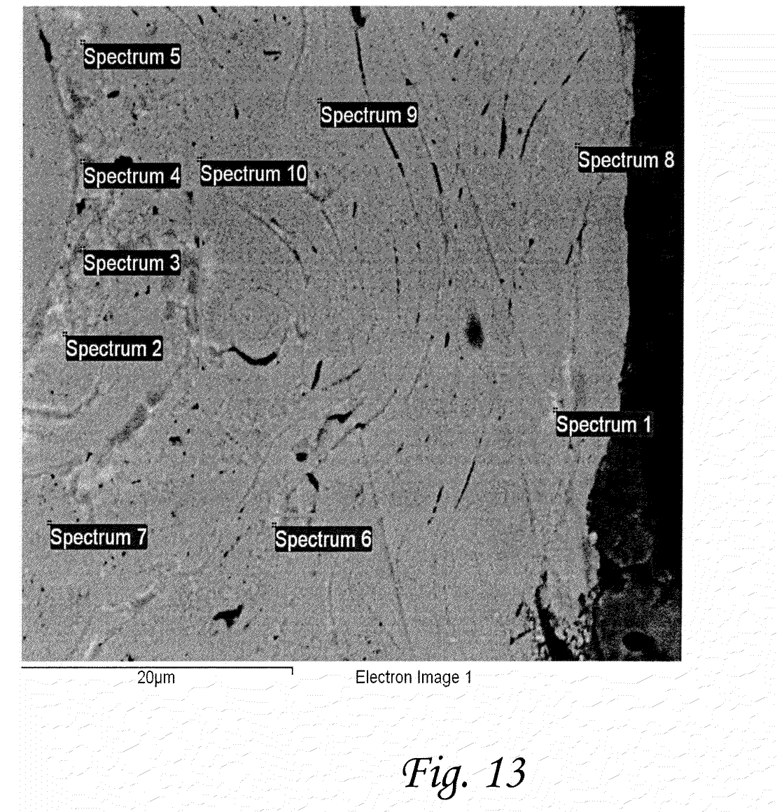

FIG. 13 is a close-up micrograph of a region near the exterior surface of the resultant coating of FIG. 11. Table 3 are energy dispersive spectroscopy results accompanying this image. The presence of lighter phases in this image indicate infiltration by the brazing material towards the exterior coating. These results are confirmed by Table 3. In some embodiments, such as the one illustrated, the brazing material preferentially infiltrates the pores of the thermal spray coatings during heat treatment. Accordingly, in these embodiments, the porosity of the resultant coating may be determined by varying the amount of brazing material used in the process.

TABLE 3
Energy dispersive spectroscopy results accompanying FIG. 13,
revealing composition according to spectrum location.

| Spectrum | Cr | Fe | Cu | Mo | Ag |
|---|---|---|---|---|---|
| 1 | 3.01 | 23.01 | | 32.67 | 27.06 |
| 2 | 3.78 | 21.45 | | 31.39 | 32.6 |
| 3 | 3.45 | 89.5 | | 7.05 | |
| 4 | 6.77 | 82.02 | 11.2 | | |
| 5 | | 22.11 | | 24.51 | 42.82 |
| 6 | 3.67 | 33.02 | | 15.31 | 40.92 |
| 7 | 8.48 | 55.02 | | 22.63 | |
| 8 | 7.84 | 53.4 | | 24.5 | |
| 9 | 9.89 | 54.17 | | 22.65 | |
| 10 | 8.3 | 52.96 | | 26.49 | |

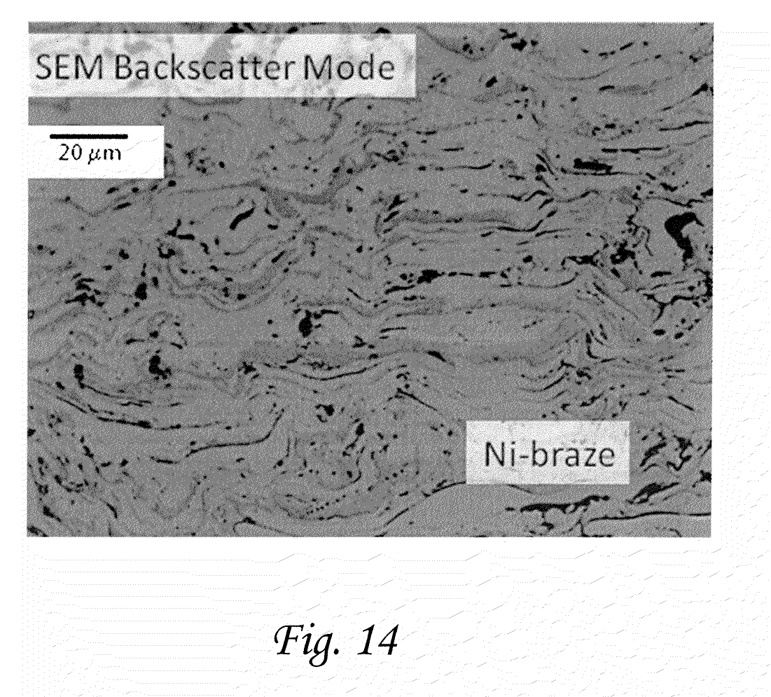

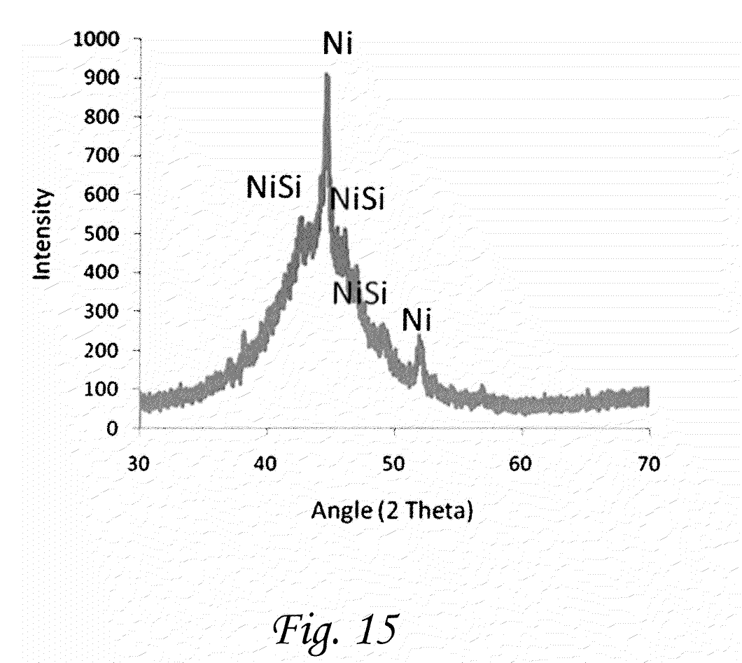

FIG. 14 illustrates a non-heat treated resultant coating formed according to the method described with respect to FIG. 5A. FIG. 15 is an x-ray diffraction spectra for this coating. Specifically, a Ni-based brazing material, Ni_{92.4}B_{3.1}Si_{4.5} was mixed in powdered form with a thermal spray coating material comprising Vecalloy, Fe_{63.4}Cr_{9.4}Mo_{12.5}C_{2.5}B_{1.8}W_{10.4}. This powder mixture comprised 90% Vecalloy and 10% brazing material and was thermally sprayed using the HVOF process on a substrate. As illustrated, the brazing material and thermal spray coating material formed a layered structure within the coating containing roughly 0.5% porosity. This resultant coating was not heat treated, and as FIG. 15 illustrates, alloying did not occur during the spraying process; the Ni-based brazing material formed distinct phases from the amorphous Fe-based material, Fe_{63.4}Cr_{9.4}Mo_{12.5}C_{2.5}B_{1.8}W_{10.4}.

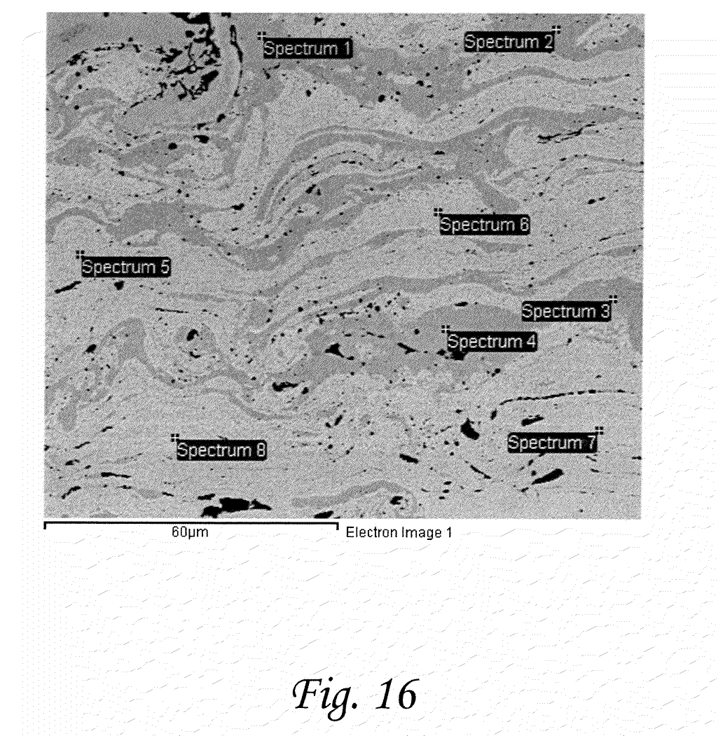

FIG. 16 is a micrograph of the resultant coating after heat treating the coating of FIG. 14. Table 4 illustrates the coating composition at the locations illustrated in FIG. 16. This coating was subjected to a heat treatment of 1050° C. for 5 min. As demonstrated by Table 4, there is significant alloying between the brazing material and the thermal spray coating material. This heat treatment also removed most or all of the through-porosity that existed before heat treatment.

TABLE 4
Energy dispersive spectroscopy results accompanying FIG. 16,
revealing composition according to spectrum location.

| Spectrum | Si | Cr | Fe | Ni | Mo | W |
|---|---|---|---|---|---|---|
| 1 | 4.30 | 1.47 | 49.64 | 44.59 | | |
| 2 | 3.19 | 1.83 | 47.28 | 47.70 | | |
| 3 | 2.93 | 0.93 | 47.18 | 48.96 | | |
| 4 | 3.38 | 1.81 | 48.84 | 45.96 | | |
| 5 | | 5.09 | 39.57 | 18.36 | 22.43 | 14.55 |
| 6 | | 11.88 | 33.12 | 11.02 | 28.30 | 15.68 |
| 7 | | 6.37 | 45.66 | 5.13 | 27.83 | 15.01 |
| 8 | | 11.40 | 48.66 | 5.31 | 21.92 | 12.72 |

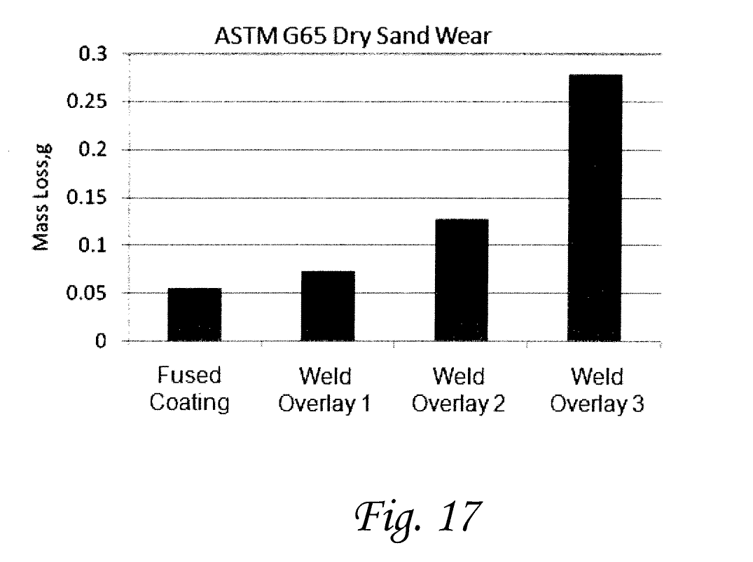

FIG. 17 is a graph illustrating the results of fused coating 241 as compared to weld-overlays in the ASTM G65 Dry Sand Wear Test. In this graph, Weld Overlay 1 comprises Fe_{67.5}Cr_{9.6}C_{2.1}B_{1.6}W_{8.8}Nb_{10.6}; Weld Overlay 2 comprises Fe_{balance}C_{0.04-0.06}Si_{0.6-1.5}Cr₂₅₋₃₀Ni₅₋₇Mn_{1.2-2.4}B_{3.2-3.7}; and Weld Overlay 3 comprises Fe_{balance}Cr_{<25}Mo_{<15}B_{<5}W_{<5}C_{<2}Mn_{<2}Si_{<2}. Fused coating 241 was formed according to the method described with respect to FIGS. 2A and 2B by first coating a substrate with 5 mils of braze material, Ni_{92.4}B_{3.1}Si_{4.5}, followed by 15 mils of Fe_{63.4}Cr_{9.4}Mo_{12.5}C_{2.5}B_{1.8}W_{10.4}, and heat treated for 5 min at 1050 C for 5 min. As these results indicate, the fused coating 241, outperforms weld overlays having similar elemental compositions. These results indicate particularly strong wear resistance because weld overlays tend to have better abrasive wear properties than thermal spray coatings. The coating process used to form coatings 240 and 241 is more cost effected than typical weld overlays and allows for a more rapid coating application than weld overlay. Furthermore, because the particles of the coating are metallurgically bound together as well as bound to the substrate, the fused coating may have improved durability in aspects such as impact durability, cavitation durability, or corrosion durability.

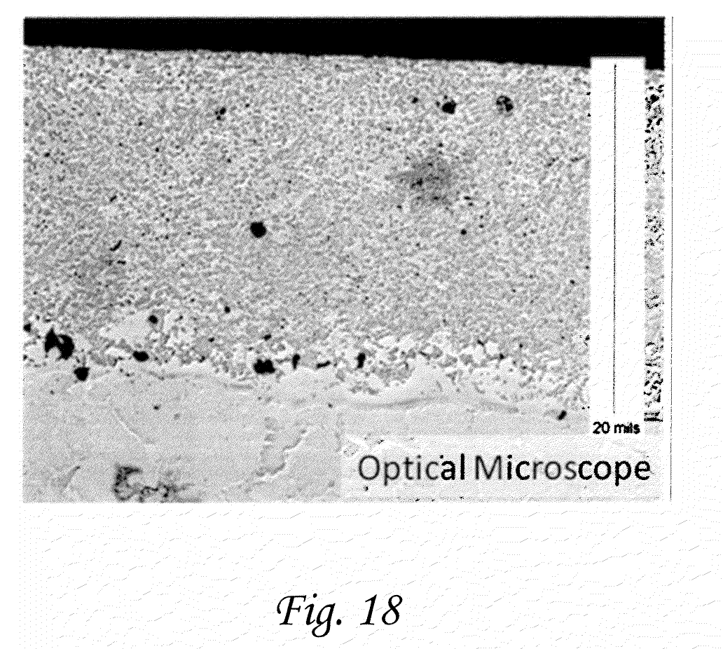

FIG. 18 illustrates an inventive resultant coating formed according to the method described with respect to FIGS. 2A and 2B. This coating was formed by pre coating a steel substrate with 5 mil sheet of BNi3, Ni_{92.4}B_{3.1}Si_{4.5}, (a commercial brazing alloy) followed by 15 mils of Fe_{63.4}Cr_{9.4}Mo_{12.5}C_{2.5}B_{1.8}W_{10.4}. The assembly was then heat treated in vacuum for 5 mins at 1050° C. This figure illustrates the resultant infiltration of the brazing material into the thermal spray coating material, and the bonding of the resultant coating to the substrate.

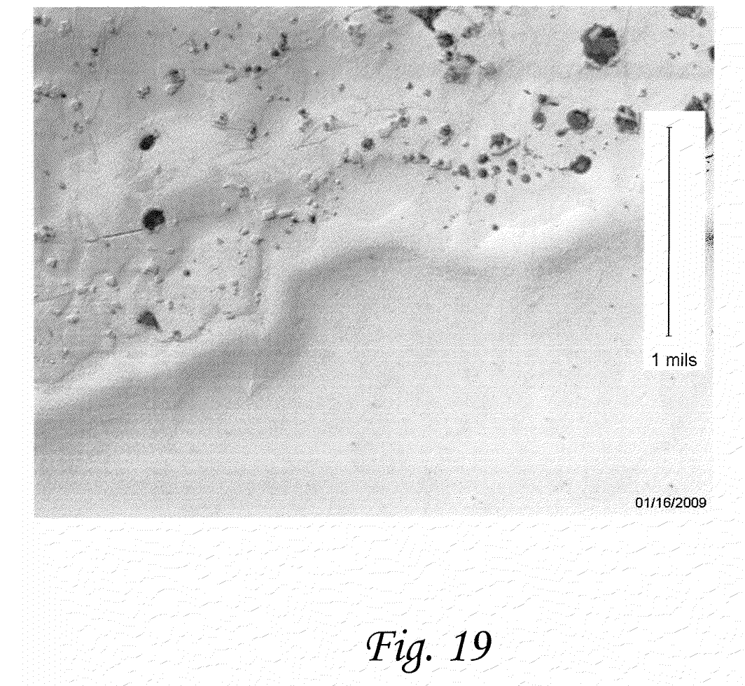

FIG. 19 illustrates a close up of the metallurgical bond between a substrate and a resultant coating formed according to the method used to produce sample 241.

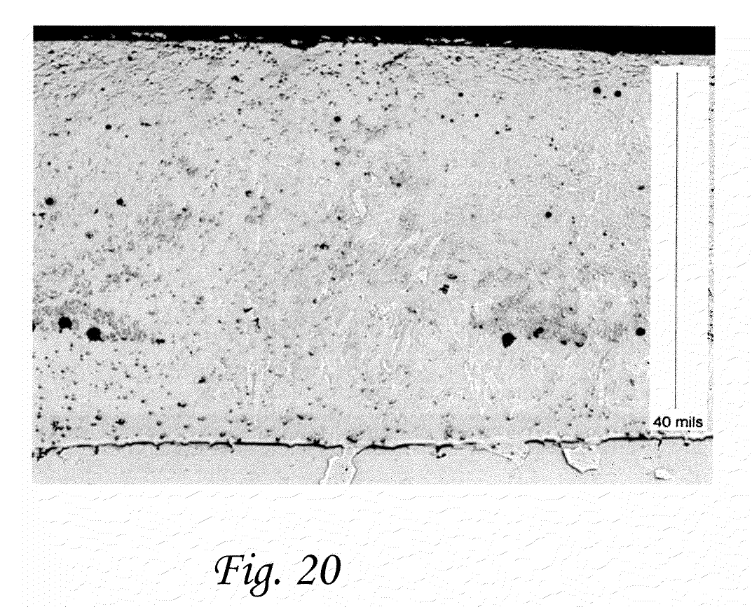

FIG. 20 is an optical micrograph of a coating formed according to an embodiment of the invention produced according to the method described with respect to FIGS. 2A and 2B. This coating was formed using 5 mils of commercial braze alloy BNi-3 followed by 15 mils of Fe_{75.8}Cr₁₀Nb₁₀B₄. After the thermal spray coating was applied, the resultant coating was heat treated in vacuum for 5 min at 1050° C. In some applications, this coating may perform well as a hard wear resistant coating.

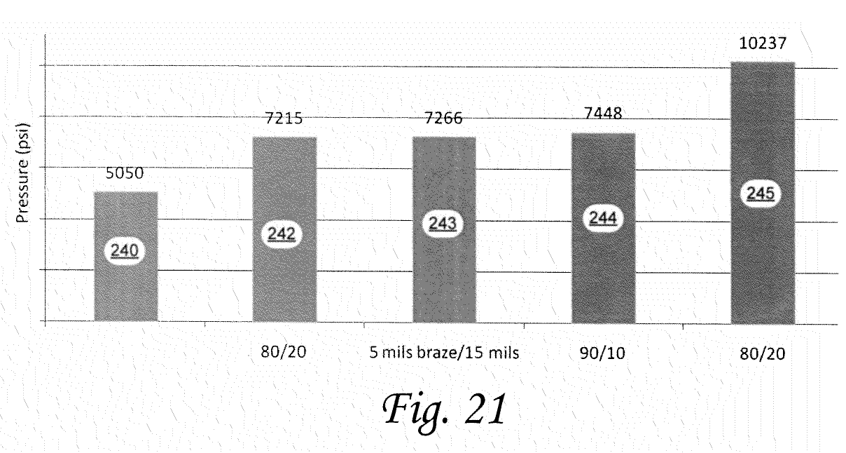

FIGS. 21-24 show various test results of coatings formed according to embodiments of the invention. In these tests, the thermal spray coating material comprised Fe_{63.4}Cr_{9.4}Mo_{12.5}C_{2.5}B_{1.8}W_{10.4} and the brazing material comprised Ni_{92.4}B_{3.1}Si_{4.5}. Coatings 242, 244, and 245, were formed by simultaneously thermally spraying the substrate with a pre-mixed powder consisting of Vecalloy, Fe_{63.4}Cr_{9.4}Mo_{12.5}C_{2.5}B_{1.8}W_{10.4}, and the braze material, Ni_{92.4}B_{3.1}Si_{4.5}. The numbers below the results indicate the ratios of thermal spray coating to brazing material. Coatings 243 was created by first coating a steel substrate with 5 mil of similar brazing material followed by 15 mils of Vecalloy. Coatings 242, 243, and 244 did not include final heat treatment steps, coatings 245 and 247 included a final heat treatment step, coatings 260 comprised heat treated thermal spray coatings without brazing material, and coatings 240 indicates a control of the thermal spray coating alone without any brazing material.

FIG. 21 is a graph showing the results of the ASTM C 633 tensile strength test of various embodiments of the invention. The numbers above the results indicate the results for adhesive failure of the materials. As these results indicate, employing the methods described herein may result in a significant strengthening of the coating's bond to the substrate. All methods resulted in at least about a 43% percent improvement in tensile strength over a standard thermal spray coating process without use of a brazing material. Furthermore, coating 245 shows that a heat treatment step can result in a more than 100% improvement over a conventional thermal spray coating process.

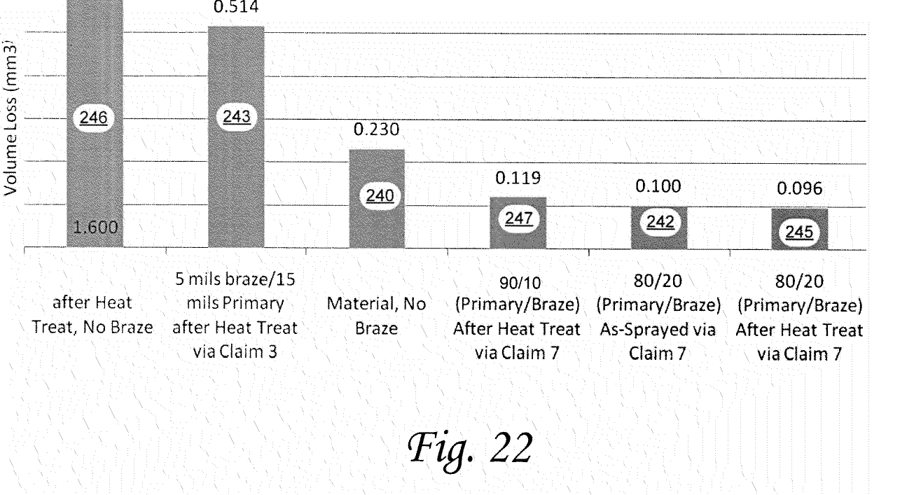

FIG. 22 illustrates the results of the ASTM G77 test (Block on Ring) showing the wear resistance as measured for various embodiment of the invention. As the figure illustrates, the coatings where the braze was applied simultaneously with the thermal spray coatings (˜0.1 mm³ of wear) show more than double the wear resistance of primary material alone (˜0.23 mm³ of wear). In these embodiments, the brazing material may be beneficial in either the as-sprayed or heat-treated condition because it acts as a binder between the individual splats produced during the thermal spray processing of the primary material.

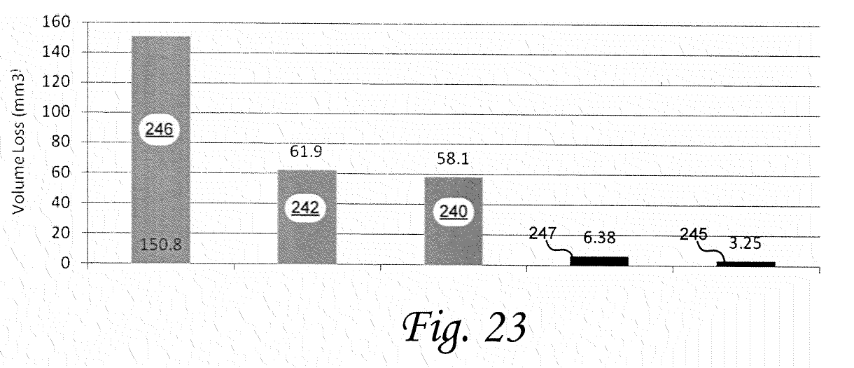

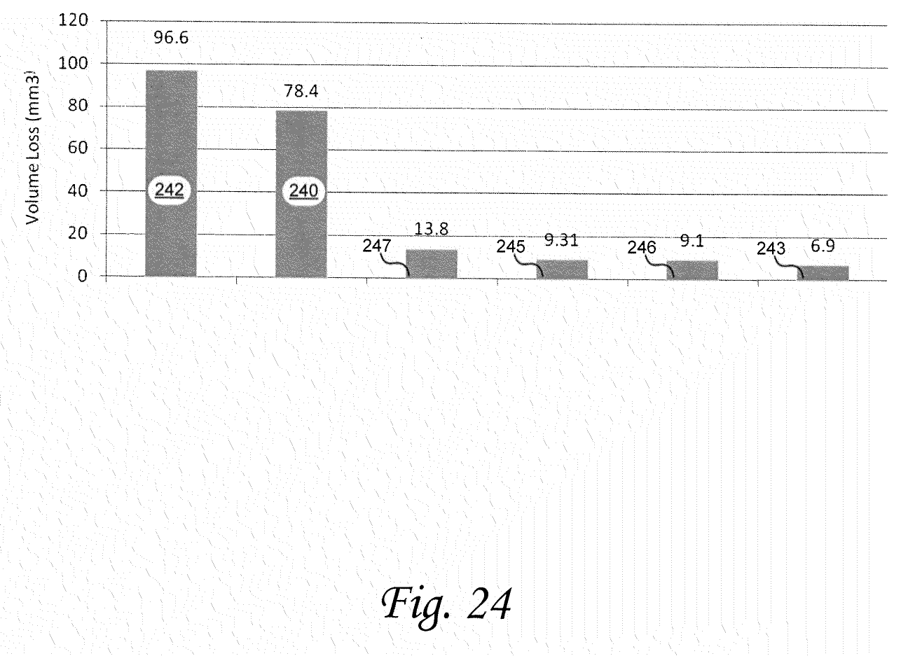

FIG. 23 illustrates the results for the indicated coatings under the ASTM G105 (Wet Sand Rubber Wheel) test. FIG. 24 illustrates the results for the indicated coatings under the ASTM G65 (Dry Sand Rubber Wheel) test. As these figures illustrate, the heat treated samples performed significantly better than the non-heat treated 242 and control samples 240 in wear resistance tests.

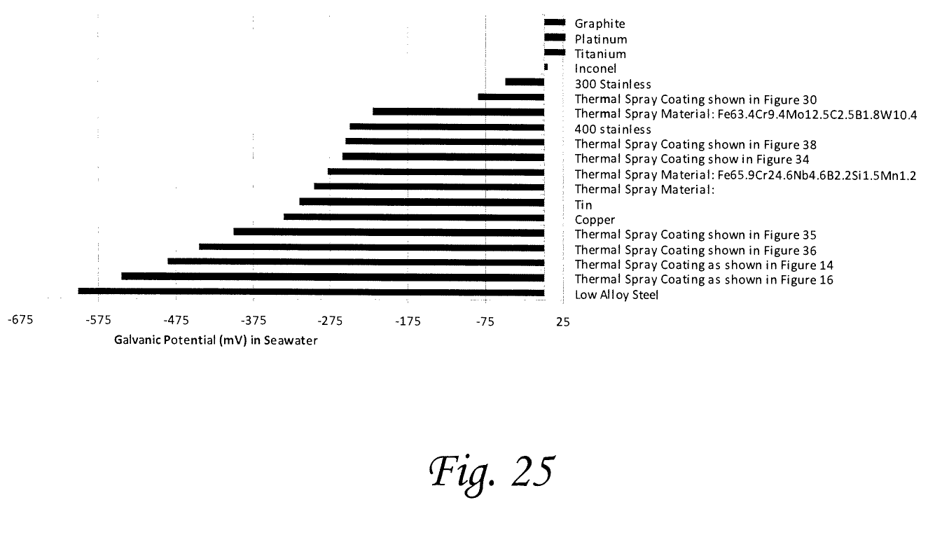

The compositions used in various embodiments of the invention can have a significant effect on the electrical potential of resultant coatings. FIG. 25 shows the galvanic series of several well known materials in addition to the materials discussed in this patent. As shown, the addition of the brazing material may significantly affect the galvanic potential of the coating in seawater in both the as-sprayed and heat-treated condition. This effect offers an additional degree of tailorability to coating design. In some applications, it is important to account for potential differences between the resultant coatings and substrates because a large potential mismatch between coating and substrate can create a self corroding battery.

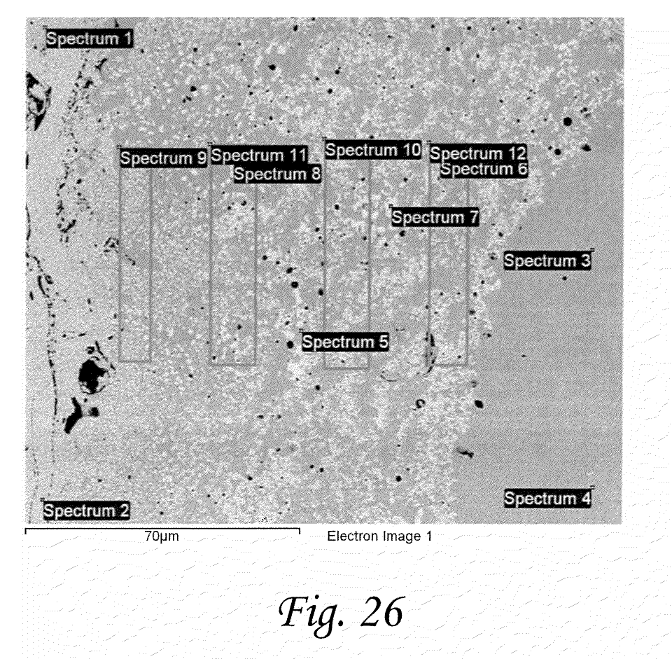

Further embodiments of the invention provide materials that may be used in applications of the invention. In addition to other uses, (Fe,Ni)-based brazing materials may increase the corrosion resistance in applications of some methods of the invention. In particular, the increased amount of Fe in these materials lowers the cost of the brazing material and gives the brazing material a more similar electrochemical potential to the Fe-base materials that typically make up substrates and thermal spray coatings. FIGS. 26-29 illustrate various materials and coatings formed according to these embodiments. FIGS. 26-29 illustrate resultant structures after the potential brazing alloys were arc-melted from laboratory grade purity elemental powders and granules into an alloy ingot then splat quenched into a thin sheet form. The alloy sheets were then sandwiched in between two thermal spray coatings and heat treated to measure the ability of the potential brazing material to infiltrate into the pores of the coating, create a strong bond between the brazed parts, and develop alloys and microstructures resistant to wear and corrosion. In addition to the materials described, other (Ni,Fe)-based materials, such as those described in Provisional U.S. Application Ser. No. 61/243,498 filed Sep. 17, 2009, may be used in some embodiments. Tables 5-7 are accompanying tables detailing the energy dispersive spectroscopy results for each micrograph. In these embodiments, the thermal spray coatings (Fe-based metallic glasses) metallurgically bond with the Ni-based brazing material in each case. Furthermore, an elemental gradients are formed from the iron-rich metallic glass (left side of each micrograph) to the Ni-rich braze (right side of each micrograph). Samples of these gradients are shown in the accompanying tables. These gradients reveal the phase and chemistry possibilities that can exist in heat treated materials of this type. Depending on the ratio of braze to primary material used in the coating, the chemistry and possible phases of the coating can be tailored to act as an effective corrosion and wear resistant barrier.

FIG. 26 shows a micrograph of a brazed joint between stainless steel and an Fe-based metallic glass using Ni₅₂B₁₇Si₃ as the brazing material.

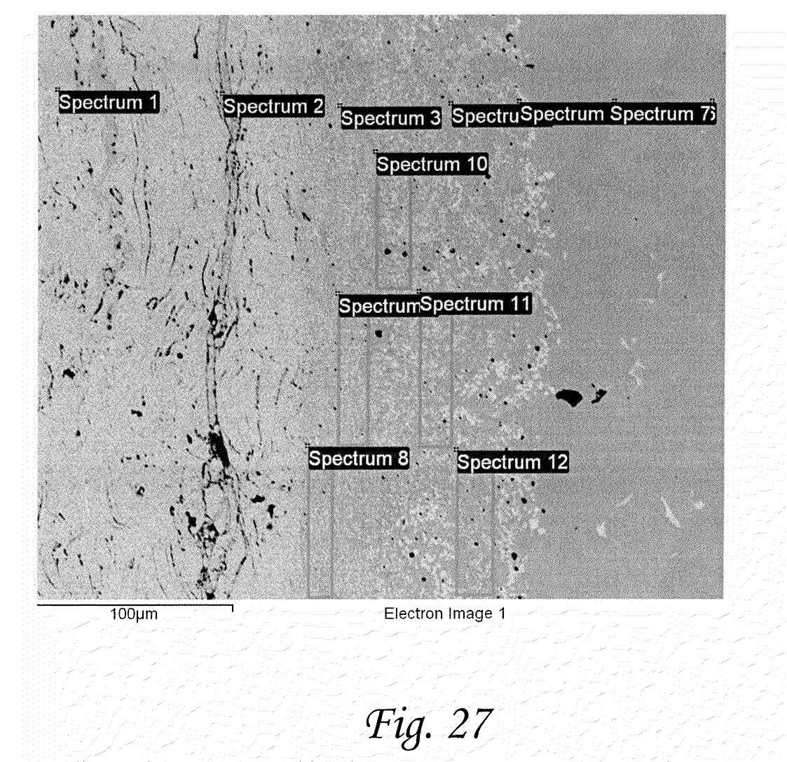

TABLE 5
Energy Dispersive Spectroscopy Results to accompany FIG. 27

| Spec. | Cr | Fe | Ni | Mo | W |
|---|---|---|---|---|---|
| 1 | 8.19 | 58.26 | | 19.59 | 13.95 |
| 2 | 7.91 | 58.09 | | 21.46 | 12.54 |
| 3 | | 40.67 | 59.33 | | |
| 4 | | 40.31 | 59.69 | | |
| 5 | | 47.10 | 52.90 | | |
| 6 | 5.26 | 53.97 | 40.78 | | |
| 7 | 4.72 | 36.72 | 31.75 | 17.15 | 9.67 |
| 8 | 5.64 | 17.48 | 6.38 | 48.06 | 22.44 |
| 9 | 7.61 | 48.99 | 19.10 | 15.47 | 8.84 |
| 10 | 3.40 | 39.09 | 34.26 | 13.61 | 9.63 |
| 11 | 4.96 | 42.65 | 29.45 | 15.19 | 7.75 |
| 12 | 3.57 | 41.66 | 33.45 | 13.80 | 7.50 |

FIG. 27 shows a micrograph of a brazed joint between stainless steel and an Fe-based metallic glass using Ni₅₅B₁₈Cr.₄Fe₂₄ as the brazing material.

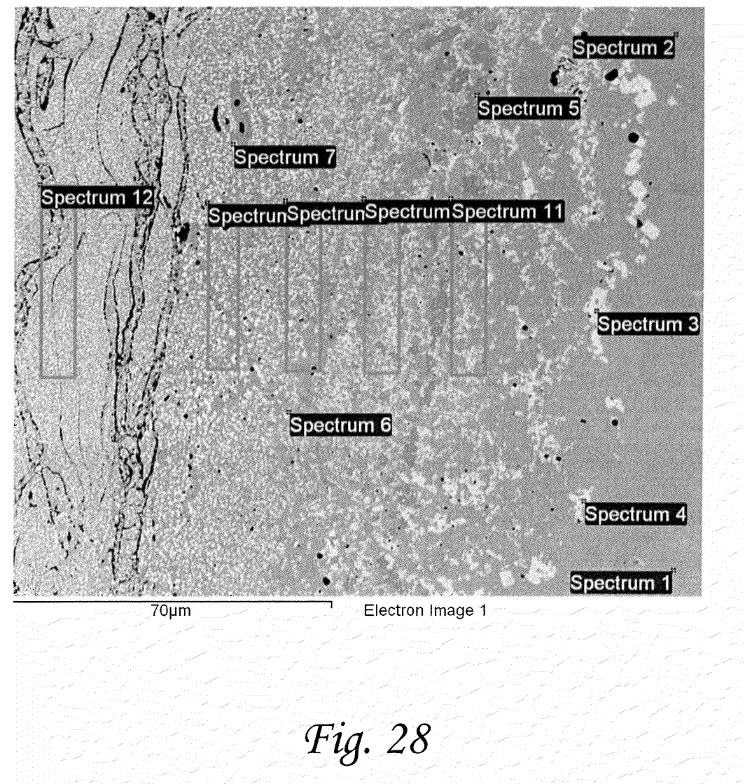

TABLE 6
Energy Dispersive Spectroscopy Results to accompany FIG. 28

| Spec. | Cr | Fe | Ni | Mo | W |
|---|---|---|---|---|---|
| 1 | 9.88 | 56.06 | | 22.95 | 11.11 |
| 2 | 6.71 | 47.64 | | 31.96 | 13.68 |
| 3 | 10.40 | 33.49 | 25.53 | 20.20 | 10.38 |
| 4 | 9.19 | 32.77 | 34.73 | 15.68 | 7.62 |
| 5 | 3.26 | 33.79 | 46.66 | 9.68 | 6.60 |
| 6 | 3.20 | 39.79 | 57.01 | | |
| 7 | 2.29 | 39.77 | 57.95 | | |
| 8 | 8.59 | 43.86 | 24.94 | 15.23 | 7.37 |
| 9 | 7.78 | 35.81 | 34.32 | 14.39 | 7.69 |
| 10 | 9.51 | 33.07 | 40.18 | 10.61 | 6.63 |
| 11 | 6.86 | 33.02 | 42.71 | 11.65 | 5.76 |
| 12 | 5.80 | 39.73 | 46.78 | 7.70 | |

FIG. 28 shows a micrograph of a brazed joint between stainless steel and an Fe-based metallic glass using Ni₅₄B₁₄Si₄Cr₄Fe₂₄ as the brazing material.

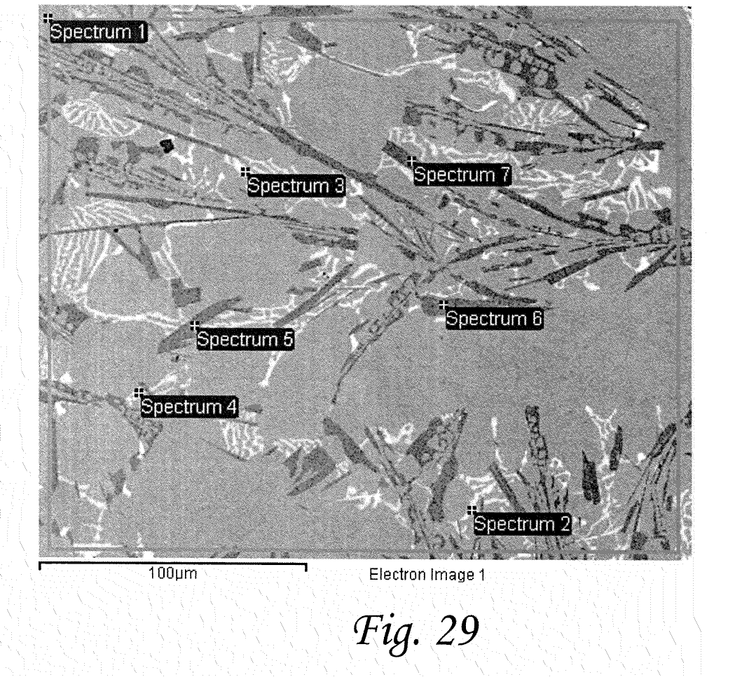

TABLE 7
Energy Dispersive Spectroscopy Results to accompany FIG. 29

| Spec. | Si | Cr | Fe | Ni | Mo | W |
|---|---|---|---|---|---|---|
| 1 | 3.47 | | 40.68 | 55.84 | | |
| 2 | 2.79 | 3.38 | 37.68 | 56.16 | | |
| 3 | | 16.27 | 20.56 | 8.07 | 38.29 | 16.80 |
| 4 | | 15.85 | 17.97 | 7.98 | 38.72 | 19.48 |
| 5 | | 43.78 | 42.30 | 8.32 | 5.60 | |
| 6 | 2.22 | | 43.08 | 54.70 | | |
| 7 | | 3.76 | 23.11 | 11.82 | 42.71 | 18.59 |
| 8 | | 9.59 | 40.45 | 20.63 | 18.99 | 10.33 |
| 9 | | 8.44 | 35.94 | 32.49 | 15.16 | 7.97 |
| 10 | | 7.80 | 32.21 | 42.01 | 11.13 | 6.84 |
| 11 | 2.49 | 7.17 | 36.28 | 44.30 | 9.76 | |
| 12 | | 8.09 | 56.28 | | 23.73 | 11.90 |

FIG. 29 shows a micrograph of a resultant coating produced via complete alloying between the brazing material Fe₄₃Cr₃₃Ni₁₀B₁₄ and an Fe-based metallic glass. In this embodiment, the Fe-based metallic glass was allowed with the brazing material at 1250° C. for 5 mins. in an open air furnace. As the figure and table indicate, alloying between the brazing material and the Fe-based metallic glass resulted in a material have a microstructure with various elemental compositions at different locations.

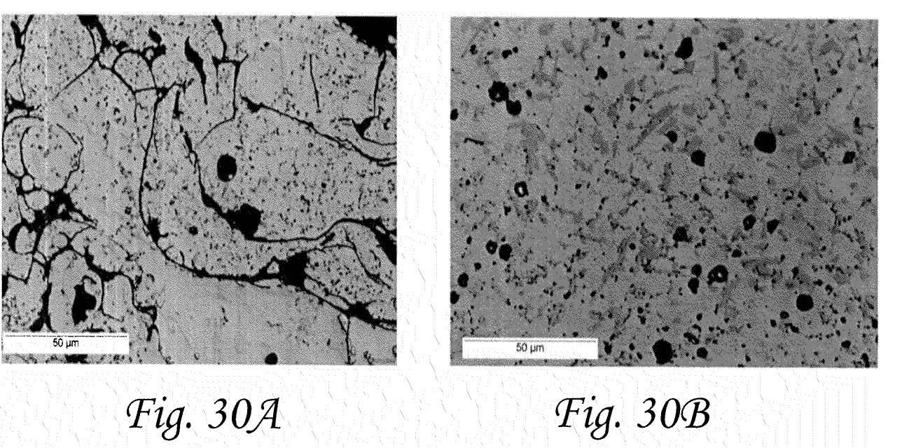

TABLE 8
Energy Dispersive Spectroscopy Results to accompany FIG. 30,
elemental concentrations in weight %

| Spec. | Cr | Fe | Ni | Nb |
|---|---|---|---|---|
| 1 | 20.42 | 68.66 | 7.2 | 3.73 |
| 2 | 11.95 | 38.38 | 2.61 | 47.06 |
| 3 | 9.78 | 40.21 | 2.8 | 47.21 |
| 4 | 4.28 | 16.01 | 1.69 | 78.01 |
| 5 | 54.88 | 45.12 | | |
| 6 | 56.19 | 43.81 | | |
| 7 | 53.18 | 46.82 | | |

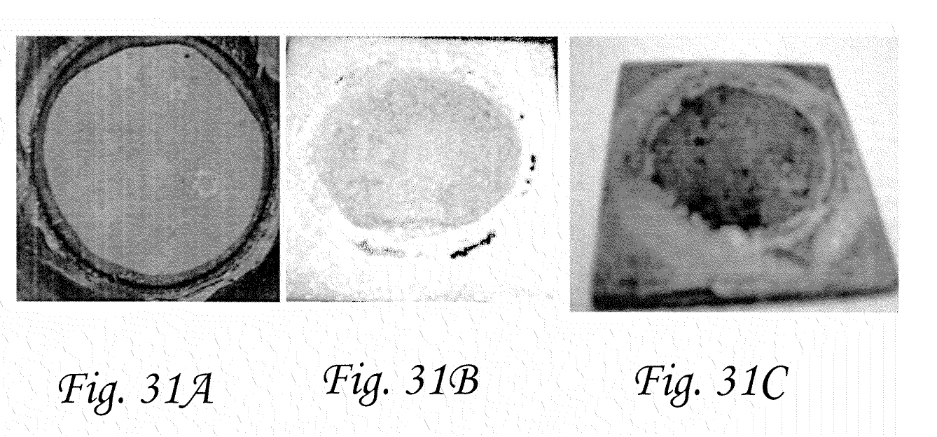

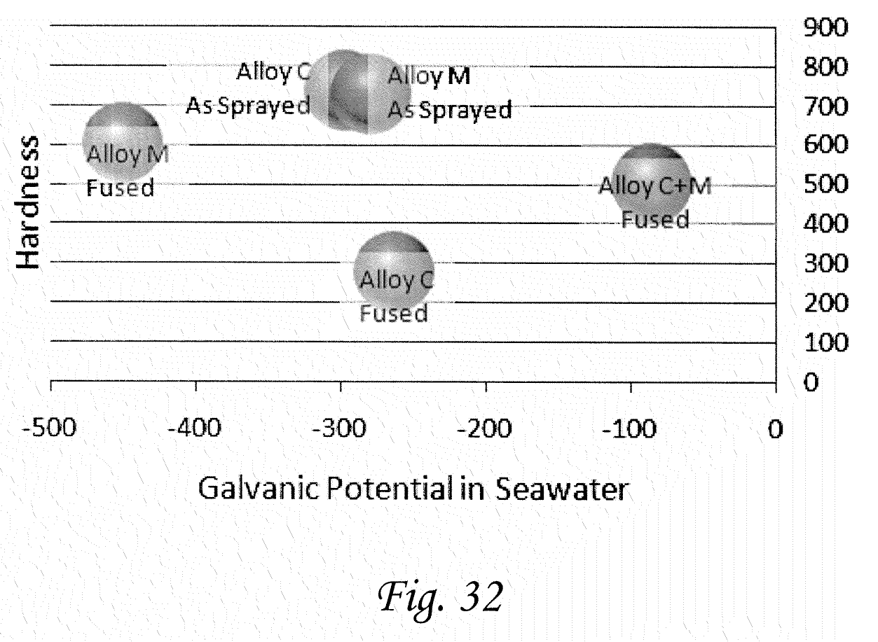

FIG. 30 is a comparison between a twin wire arc spray coating and a fused coating formed according to the method described with respect to FIG. 2. The fused coating was produced using Fe_{65.9}Cr_{24.6}Nb_{4.6}B_{2.2}Si_{1.5}Mn_{1.2} as a 5 mil pre-coat and Fe₆₆Cr_{14.5}Nb_{8.5}Ni₅Si₁Mn₁ as a 8 mil topcoat and heat treated at 1175 C in vacuum for 5 min. FIG. 32 illustrates the results of a test comparison under corrosive conditions in salt water with 316 stainless steel serving as the reference electrodes. FIG. 32A is the results using the coating of FIG. 31B, FIG. 31B is an unfused twin wire arc thermal spray coating using Fe_{balance}C_{0.04-0.06}Si_{0.6-1.5}Cr₂₅₋₃₀Ni₅₋₇Mn_{1.2-2.4}B_{3.2-3.7}, and FIG. 32C is an unfused twin wire arc thermal spray coating using Fe_{balance}Cr_{<25}Mo_{<15}B_{<5}W_{<5}C_{<2}Mn_{<2}Si_{<2}. As the figure indicates, the inventive coating had showed almost no visible rust, while the other coatings were significantly corroded.

In further embodiments, other thermal spray coatings may serve as what has been termed brazing materials herein. For example, FIG. 32 illustrates the hardness of and galvanic potential of coatings formed using thermal spray coatings in the illustrated combinations. In FIG. 32, Alloy M comprises Fe_{65.9}Cr_{24.6}Nb_{4.6}B_{2.2}Si_{1.5}Mn_{1.2}, and Alloy C comprises Fe_{65.6}Cr_{14.5}Nb_{8.6}B_{4.2}Ni_{4.8}Si_{1.1}Mn_{1.2}, and the term fuse refers to heat treating the layered coatings such that the materials infiltrate each other and possibly alloy. As the results indicate, in applications where high hardness are corrosion resistance are beneficial, the use of two thermal spray coatings that are fused provides better results than either alloy alone, whether self-fused or not.

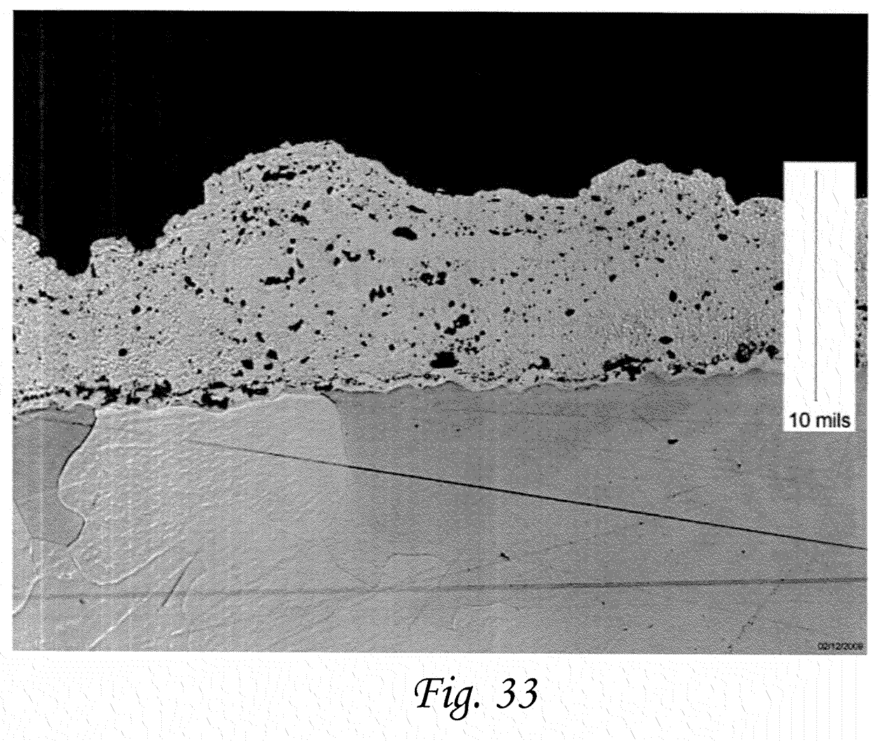

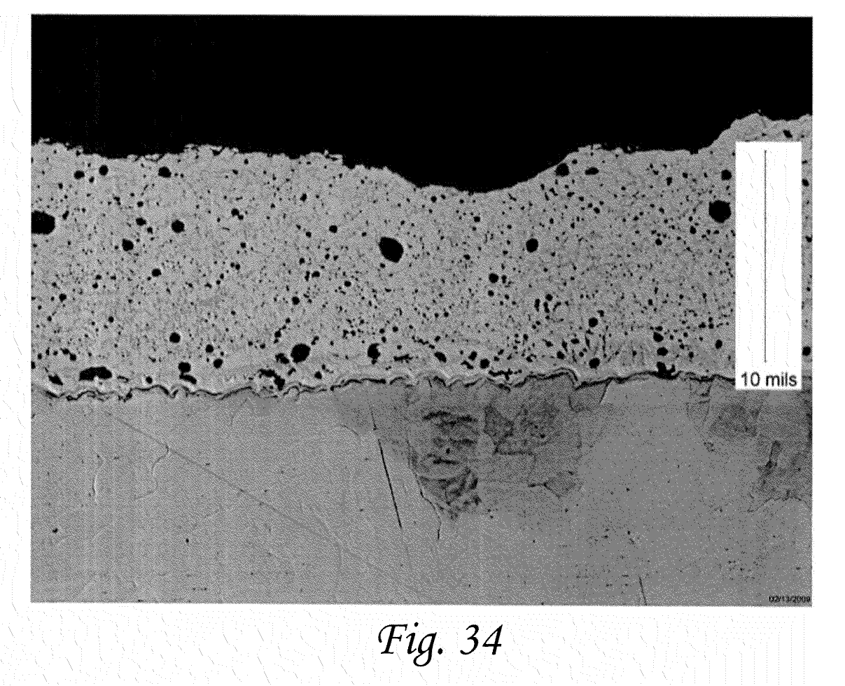

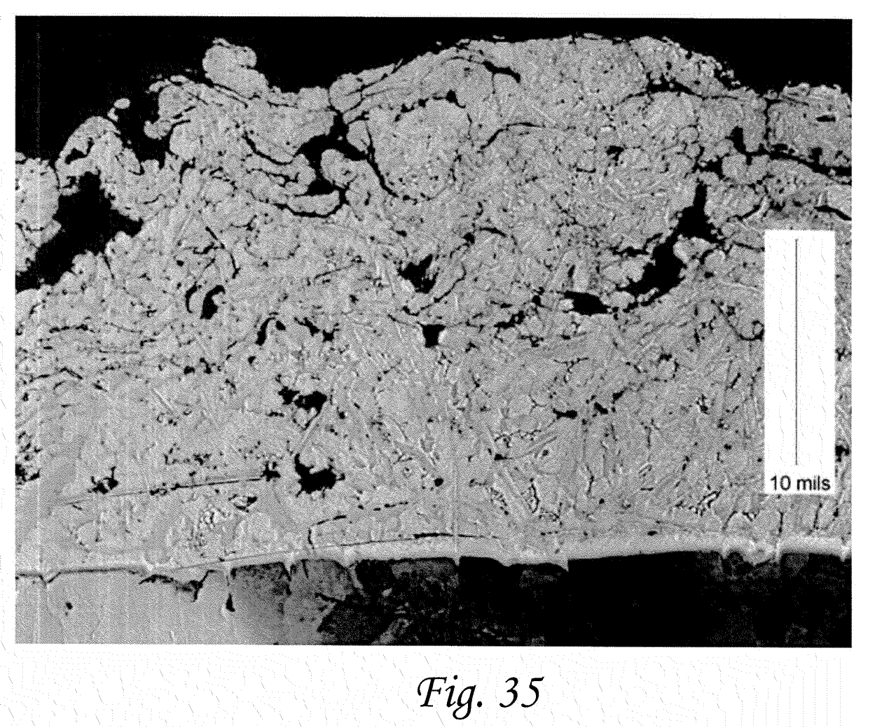

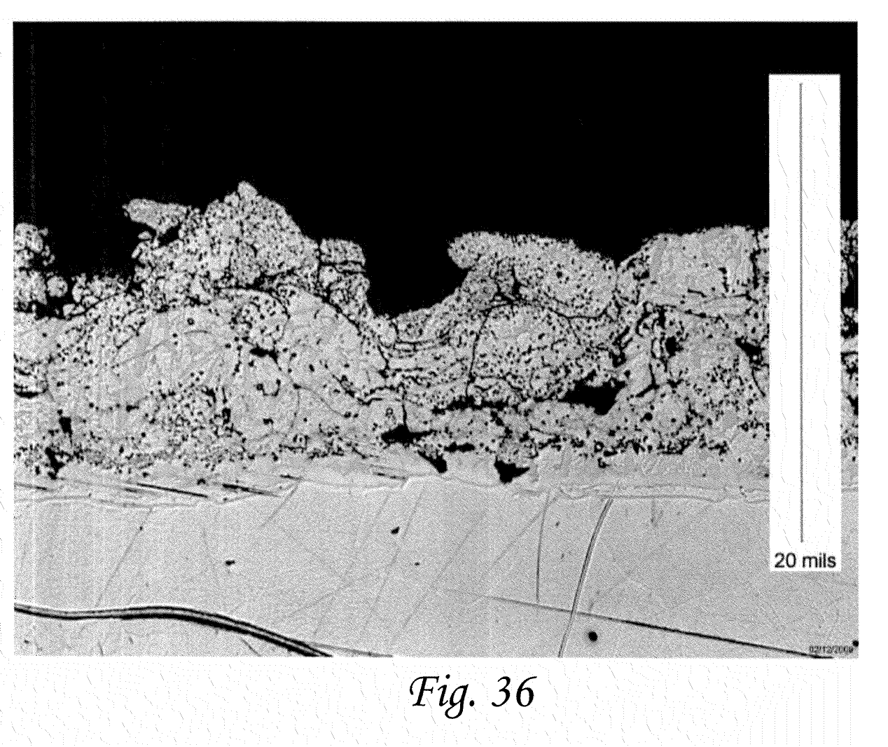

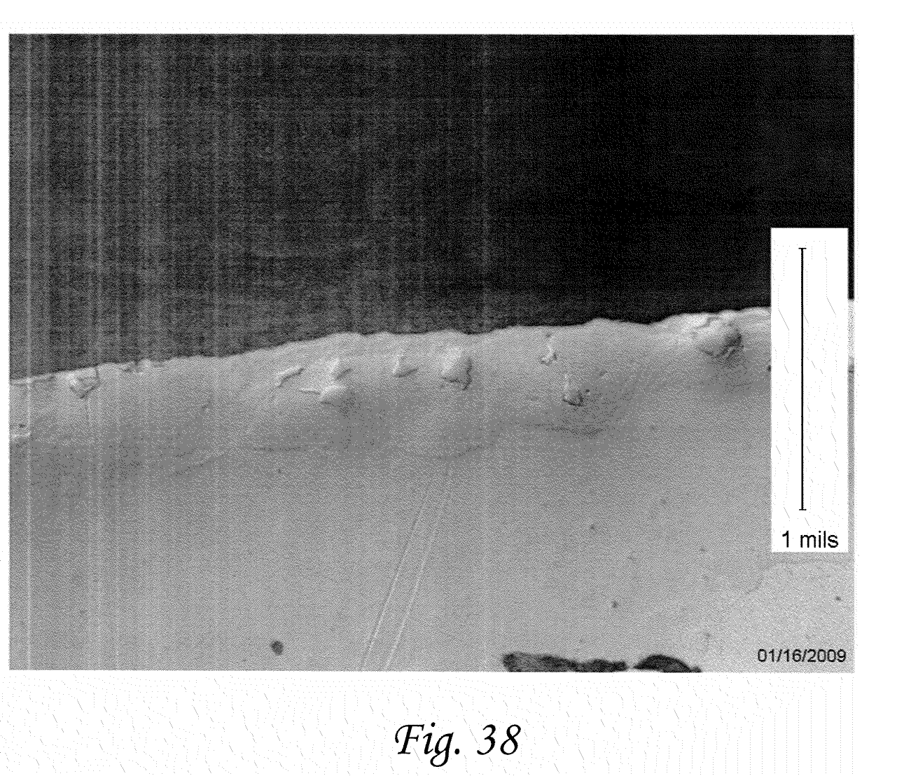

FIGS. 33-37 illustrate a number of corrosion resistant resultant coatings according to various embodiments of the invention. These coating eliminate through porosity, thereby reducing the ability of a corrosive media to directly corrode the substrate. FIG. 33 is an optical micrograph of a resultant coating formed by 8 mils pre-coating of Fe_{65.9}Cr_{24.6}Nb_{4.6}B_{2.2}Si_{1.5}Mn_{1.2} followed by 15 mil coating of Fe_{65.6}Cr_{14.5}Nb_{8.6}B_{4.2}Ni_{4.8}Si_{1.1}Mn_{1.2} that was heat treated in vacuum for 5 min at 1175 C. FIG. 34 is an optical micrograph of a resultant coating formed by 8 mils pre-coating of BNi-1a, (Ni_{73.9}Cr₁₄Fe_{4.5}B_{3.1}Si_{4.5}) followed by 15 mil coating of Fe_{65.6}Cr_{14.5}Nb_{8.6}B_{4.2}Ni_{4.8}Si_{1.1}Mn_{1.2} heat treated in vacuum for 5 min at 1175 C. FIG. 35 is an optical micrograph of a coating formed by 8 mils pre-coating of BNi-1a followed by 15 mil coating of Fe₇₂Cr₁₃Nb₆Ni₅Si₁Mn₁Al₂ heat treated in vacuum for 5 min at 1175 C. FIG. 36 is an optical micrograph of a coating formed by 8 mils pre-coating of Fe_{65.9}Cr_{24.6}Nb_{4.6}B_{2.2}Si_{1.5}Mn_{1.2} followed by 15 mil coating of Fe₇₂Cr₁₃Nb₆Ni₅Si₁Mn₁Al₂ heat treated in vacuum for 5 min at 1175 C. FIG. 38 is an optical micrograph of a coating formed by 8 mils pre-coating of BNi-3, Ni_{92.4}B_{3.1}Si_{4.5}, followed by 15 mil coating of Fe_{65.9}Cr_{24.6}Nb_{4.6}B_{2.2}Si_{1.5}Mn_{1.2} heat treated in vacuum for 5 min at 1175 C.

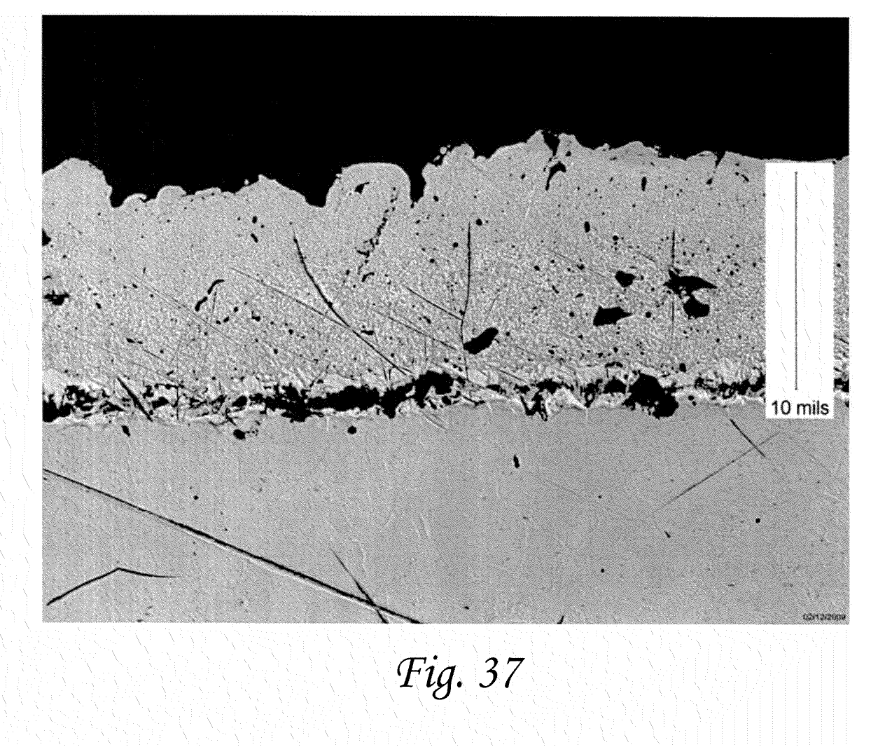

FIG. 37 also illustrates a possible outcome if the brazing process is performed incorrectly. In the various embodiments described herein, the initial thicknesses of the brazing materials and thermal spray coating materials may vary depending on the application in which the embodiment will be used. For example, some embodiments described herein have typical braze material initial thicknesses between 1-8 mils and thermal spray coating material thicknesses between 10-20 mils. However, different applications of the invention may use varying coating thicknesses. Although, as discussed above, in a thermal spray, there may be a maximal thickness, where the coating begins to peel away above this maximal thickness. In some cases, this occurs because residual thermals stresses caused by splat particles hitting the substrate as a liquid, cooling, and then contracting. Generally, this maximal thickness is material dependent. In embodiments described herein, this maximal thickness may depend on the material properties of the thermal spray coating materials, the brazing materials, and the articles or substrates that are being coated or treated. In the illustrated example, the residual thermal stresses present from both the brazing material layer and the thermal spray coating layers overcame the bonding strength between the brazing material and the substrate. Accordingly, the brazing material bonded with the coating but did not sufficiently bond to the substrate, which resulted in a separation of the coating from the substrate resulting in a coating that will likely peel off the substrate under relatively low stresses.

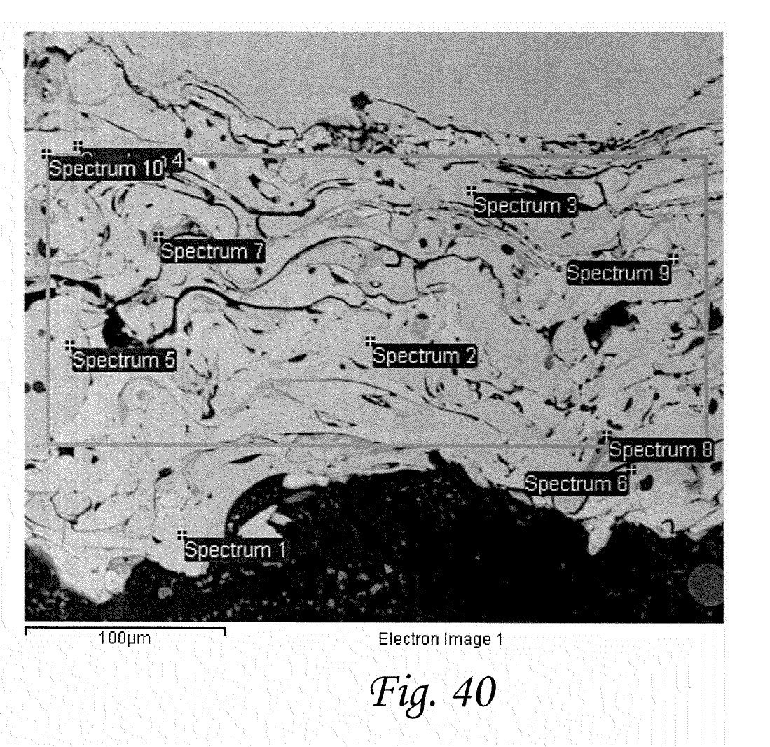

In further embodiments, the resultant coating formed can made to diffuse into the substrate to create a functional composition gradient in the bulk of the article. In these embodiments, a base thermal spray coating is not used. In some applications, these embodiments may be employed in situations where thermal cycling might result in coating failure in most thermal spray or weld overlays. FIG. 38 shows a microstructure of an embodiment where spraying 15 mils of Fe_{65.9}Cr_{24.6}Nb_{4.6}B_{2.2}Si_{1.5}Mn_{1.2} were sprayed onto a substrate and heat treated for at least 5 min at 1200 C or above. FIG. 40 shows the compositional gradient of this coating as measured using electron dispersion spectrometry in a SEM. This particular embodiment produced a thin layer of hard boride particles on the surface, and a Cr and Ni compositional gradient which extended into the bulk of the material. In these embodiments, the smooth compositional gradient may prevent a sharp thermal expansion step between coating and substrate. Accordingly, these embodiments may serve as corrosion resistant coatings for mild steel in an environment with constant thermal cycling where common stainless steels applied as either a weld or thermal spray would fail due to large differences in thermal expansion coefficients between these materials.

In further embodiments, aluminum or aluminum alloys may be used as brazing materials, either in place of or in addition to the other brazing materials described herein. FIG. 40 shows a microstructure of a resultant coating according to one such embodiment of the invention. In this embodiment, a cored wire was made by inserting a solid aluminum wire in a wire having a powder filled core. The resulting composition resulted in the desired Fe-based amorphous alloy in addition to 5 weight % aluminum. The result of thermal spraying such a wire was similar to thermal spraying a braze/desired alloy powder mixture via HVOF or plasma spray in that the aluminum acted to bond the splat particles together in the as-sprayed condition. Table 9 is are electron dispersion spectrometry results at the various locations indicated on the figure. As the figure and accompanying table shows, the aluminum is thoroughly mixed within the coating structure. In this embodiment, this combination acts to increase the bond strength and reduce the porosity in the coating, as the soft aluminum phase flows between the hard amorphous phase splats and holds them together. The porosity of coatings produced under similar conditions and using similar relative compositions excluding aluminum decreases from 1.65% for a wire not containing an aluminum rod to 1.2% for a wire containing an aluminum rod. The tensile bond strength increases from 6100-8200 psi in the cored wire not containing the aluminum to 9300-10,200 psi for the alloy containing the aluminum as measured via the ASTM C 633 standard.

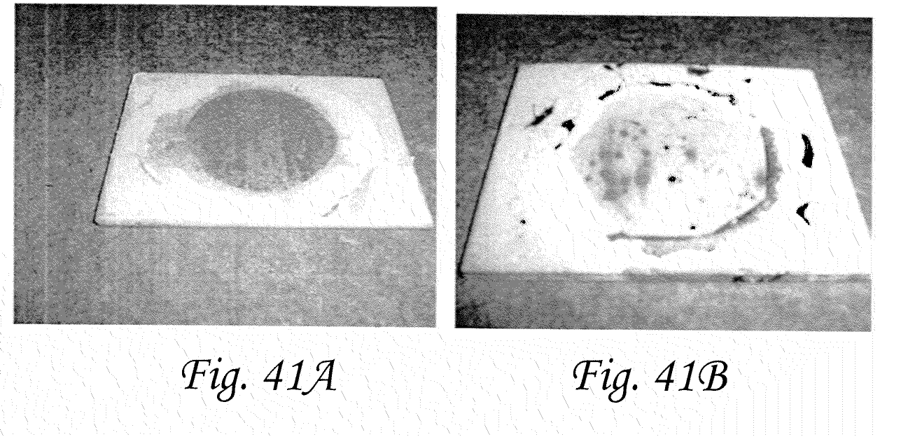

In still further embodiments, the use of aluminum can be added to braze and thermal spray coating techniques. In these embodiments, in addition to creating a mechanically stronger coating, the brazing material also acts as a sacrificial anode to the coating in highly corrosive conditions. FIG. 41 illustrates the results of a corrosion test where the two cored wires of similar relative composition expect for the aluminum, were placed in a galvanic cell relative to 316 stainless steel with natural saltwater from the San Francisco Bay as the electrolytic solution. FIG. 41A illustrates the results for an Fe-based amorphous alloy without aluminum, while FIG. 41B illustrates with same alloy with 2% added by weight aluminum. Both samples showed an anodic potential relative to stainless steel. After 14 days the coating produced without the aluminum brazing material showed extensive and complete corrosion across the entire exposed area, while the coating produced with the aluminum showed significantly less corrosion.

As used herein, the term article may refer to an unprocessed article to be coated and to the article during any intermediate processing steps. As used herein, the term coating may refer to a material that is layered upon an article such as a substrate having a distinct interface between the coating material into the article; the term coating may also refer to a material that has at least partially diffused into or alloyed with the article.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments. Additionally, with regard to flow diagrams, operational descriptions and method claims, the order in which the steps are presented herein shall not mandate that various embodiments be implemented to perform the recited functionality in the same order unless the context dictates otherwise.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

As used herein, the term “article” may refer to an unprocessed article to be coated and to the article during any intermediate processing steps. As used herein, the term “coating” may refer to a material that is layered upon an article such as a substrate having a distinct interface between the coating material into the article; the term coating may also refer to a material that has at least partially diffused into or alloyed with the article. In the formulae for compounds described herein, the notation (X,Y)ₐ means that the element X, or the element Y, or a combination thereof are present in the compound in weight percentage a. Unless otherwise indicated, compound formulae are presented in weight percentage. The presence of broadening words and phrases such as “one or more,” “at least,” “but not limited to” or other like phrases in some instances shall not be read to mean that the narrower case is intended or required in instances where such broadening phrases may be absent.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

1. A method for coating an article, comprising:
applying a thermal spray coating to the article;
applying a brazing material to the article; and
heating the brazing material to at least a brazing temperature of the brazing material to form a resultant coating on the article, wherein the resultant coating is characterized by at least partial metallurgical bonding or at least partial alloying between the thermal spray coating and the brazing material.

2. The method of claim 1, further comprising heating the brazing material such that the brazing material at least partially infiltrates the thermal spray coating.

3. The method of claim 2, wherein the brazing material at least partially infiltrates the thermal spray coating to a predetermined depth of the thermal spray coating.

4. The method of claim 1, wherein the brazing material at least partially alloys with the thermal spray coating.

5. The method of claim 2, further comprising heating the brazing material to form an alloy of the brazing material and the thermal spray coating.

6. The method of claim 5, wherein the alloy is formed at an infiltration site of the brazing material.

7. The method of claim 5, further comprising heating the substrate or at least a portion of the alloyed thermal spray coating and brazing material such that the at least a portion of the alloyed thermal spray coating and brazing material diffuses into the substrate.

8. The method of claim 1, further comprising spraying the thermal spray coating on the brazing material; wherein the steps of applying the brazing material to the article and applying the thermal spray coating to the article comprise applying the coated brazing material to the article; and further comprising heating the coated brazing material such that the coated brazing material bonds with the substrate.

9. The method of claim 1, wherein the step of applying the brazing material to the article comprises at least partially coating the article with the brazing material; and wherein the step of applying the thermal spray coating to the article comprises spraying the at least partially coated article with the thermal spray coating.

10. The method of claim 9, further comprising heating brazing material such that the brazing material at least partially infiltrates the thermal spray coating.

11. The method of claim 1, wherein the step of applying the thermal spray coating to the article comprises spraying the article with the thermal spray coating; and comprises applying the brazing material to the sprayed article.

12. The method of claim 1, wherein the step of applying the thermal spray coating and applying the brazing material occur simultaneously.

13. The method of claim 12, wherein the steps of applying the thermal spray coating and applying the brazing material comprise thermally spraying the article with a powdered mixture of the thermal spray coating and the brazing material.

14. The method of claim 1, wherein an interface is formed between the resultant coating and the article; and further comprising heating the brazing material until the brazing material accumulates at the interface between the resultant coating and the substrate.

15. The method of claim 14, further comprising removing the resultant coating from the substrate.

16. The method of the claim 1, wherein the step of heating comprises causing the braze material to exothermically react with a component in the thermal spray coating.

17. A method of coating an article, comprising:
coating an article comprising a substrate with a brazing material; and
heating the brazing material such that the brazing material diffuses into the substrate.

18. The method of claim 17, wherein the step of coating comprises applying at least 15 mils of Fe_{65.9}Cr_{24.6}Nb_{4.6}B_{2.2}Si_{1.5}Mn_{1.2} to the substrate and wherein the step of heating comprises heating the coating or the article for at least 5 min at least 1200° C.

19. A protective coating, comprising:
a brazing material;
a thermal spray coating material; and
characterized by at least partial metallurgical bonding or at least partial alloying between the thermal spray coating and the brazing material.

20. The protective coating of claim 19, wherein the brazing material comprises Ni_{92.4}B_{3.1}Si_{4.5}, Ni_{73.9}Cr₁₄Fe_{4.5}B_{3.1}Si_{4.5}, or a first amorphous, partially amorphous or microcrystalline metal comprising and wherein the thermal spray coating comprises a second metal comprising Fe.

21. The protective coating of claim 20, wherein the brazing material or the thermal spray coating material comprises a metal formed according to at least one of the formulae Fe₅₄₋₇₅Cr₉₋₁₅ Ni_{0-4.8}(Mo,Nb)_{7.9-13}C_{1.6-3}B_{1.3-4.6}W₀₋₁₁Ti₀₋₇Si_{0-1.1}Mn_{0-1.1}; (Fe₆₁₋₇₅Cr_{9-14.4} Ni_{0-4.8}(Mo,Nb)_{6-11.7}C_{1.6-2.1}B_{1.3-4.6}W_{0-9.98}Ti₀₋₇Si_{0-1.1}Mn_{0-1.1})₁₀₀₋ₓAlₓ where x ranges from 0.5-10; Fe₆₂₋₆₆Cr₁₃₋₂₅(Mo,Nb)₄₋₁₂(C,B)_{2.2-4.4}Ni_{0-4.8}Si_{0-1.5}Mn_{0-1.2}W_{0-3.8}; Fe₆₁₋₇₆Cr_{9-14.4} Ni₀₋₅(Mo,Nb)_{7.9-11.7}C_{1.6-2.1}B_{1.3-5}W_{0-9.98}Ti₀₋₇Si_{0-1.1}Mn_{0-1.1}; and Fe₆₂₋₆₆Cr₁₃₋₂₅(Mo,Nb)₄₋₁₂(C,B)_{0-4.4}Ni₀₋₅Si_{0-1.5}Mn_{0-1.2}W_{0-3.8}.

22. The protective coating of claim, wherein the brazing material or the thermal spray coating material comprises a metal selected from the group comprising Fe_{63.4}Cr_{9.4}Mo_{12.5}C_{2.5}B_{1.8}W_{10.4}, Fe_{75.8}Cr₁₀Nb₁₀B_{4.7}, Fe₆₆Cr_{14.5}Nb_{8.5}Ni₅Si₁Mn₁, Fe₇₂Cr₁₃Nb₆Ni₅Si₁Mn₁Al₂, Fe_{65.9}Cr_{24.6}Nb_{4.6}B_{2.2}Si_{1.5}Mn_{1.2}, Fe_{65.9}Cr_{24.6}Nb_{4.6}B_{2.2}Si_{1.5}Mn_{1.2}, Fe_{65.9}Cr_{24.6}Nb_{4.6}B_{2.2}Si_{1.5}Mn_{1.2}, and Fe₇₂Cr₁₃Nb₆Ni₅Si₁Mn₁Al₂.

23. The protective coating of claim 22, wherein the coating is formed by heating the brazing material and the thermal spray coating material at least 1010° C. for at least 5 min.

24. The protective coating of claim 23, wherein the brazing material comprises a coating of BNi-3 having a thickness of 1-5 mils before heating and wherein the thermal spray coating comprises a coating of Fe_{63.4}Cr_{9.4}Mo_{12.5}C_{2.5}B_{1.8}W_{10.4} having a thickness of 10-15 mils before heating.

25. The protective coating of claim 23, wherein the brazing material comprises a coating of BNi-3 having a thickness of 1-5 mils before heating and wherein the thermal spray coating comprises a coating of Fe_{75.8}Cr₁₀Nb₁₀B_{4.7} having a thickness of 10-15 mils before heating.

26. The protective coating of claim 23, wherein the brazing material comprises a coating of BNi-1a having a thickness of 1-8 mils before heating and wherein the thermal spray coating comprises a coating of Fe₆₆Cr_{14.5}Nb_{8.5}Ni₅Si₁Mn₁ having a thickness of 10-20 mils before heating, and wherein the coating is formed by heating the brazing material and the thermal spray coating at between 1150 and 1200° C.

27. The protective coating of claim 23, wherein the brazing material comprises a coating of BNi-1a having a thickness of 1-8 mils before heating and wherein the thermal spray coating comprises a coating of Fe₇₂Cr₁₃Nb₆Ni₅Si₁Mn₁Al₂ having a thickness of 10-20 mils before heating, and wherein the coating is formed by heating the brazing material and the thermal spray coating at between 1150 and 1250° C.

28. The protective coating of claim 23, wherein the brazing material comprises a coating of BNi-1a having a thickness of 1-8 mils before heating and wherein the thermal spray coating comprises a coating of Fe_{65.9}Cr_{24.6}Nb_{4.6}B_{2.2}Si_{1.5}Mn_{1.2} having a thickness of 10-20 mils before heating, and wherein the coating is formed by heating the brazing material and the thermal spray coating at between 1150 and 1250° C.

29. The protective coating of claim 23, wherein the brazing material comprises a coating of Fe_{65.9}Cr_{24.6}Nb_{4.6}B_{2.2}Si_{1.5}Mn_{1.2} having a thickness of 1-8 mils before heating and wherein the thermal spray coating comprises a coating of Fe₆₆Cr_{14.5}Nb_{8.5}Ni₅Si₁Mn₁ having a thickness of 10-20 mils before heating, and wherein the coating is formed by heating the brazing material and the thermal spray coating at between 1150 and 1250° C.

30. The protective coating of claim 23, wherein the brazing material comprises a coating of Fe_{65.9}Cr_{24.6}Nb_{4.6}B_{2.2}Si_{1.5}Mn_{1.2} having a thickness of 1-8 mils before heating and wherein the thermal spray coating comprises a coating of Fe₇₂Cr₁₃Nb₆Ni₅Si₁Mn₁Al₂ having a thickness of 10-20 mils before heating, and wherein the coating is formed by heating the brazing material and the thermal spray coating at between 1150 and 1250° C.
